(19) United States
(12) Patent Application Publication
(10) Pub. No.: US 2012/0056480 A1
(43) Pub. Date: Mar. 8, 2012

(54) Control device, electronic apparatus, timepiece device, and control method

(76) Inventors: Kazumi Sakumoto, Chiba-shi (JP); Kazuo Kato, Chiba-shi (JP); Hiroshi Shimizu, Chiba-shi (JP); Saburo Manaka, Chiba-shi (JP); Keishi Honmura, Chiba-shi (JP); Kosuke Yamamoto, Chiba-shi (JP); Kenji Ogasawara, Chiba-shi (JP)

(21) Appl. No.: 13/199,498

(22) Filed: Aug. 31, 2011

(30) Foreign Application Priority Data
Sep. 3, 2010 (JP) 2010-198084
Dec. 22, 2010 (JP) 2010-286681
Jul. 1, 2011 (JP) 2011-147387

(51) Int. Cl. H02J 1/10; G05F 1/10

(52) U.S. Cl. 307/43; 323/234; 323/265

(57) ABSTRACT

There are provided an operation input unit that pulls down or pulls up a signal input from an operating unit, a control unit that executes a predetermined operation according to the signal input through the operation input unit, and a power control unit that controls the control unit so as not to execute the predetermined operation and also controls the input unit so as not to pull down or pull up the signal according to a state of supplied electric power.

### BACKGROUND OF THE INVENTION

1. Field of the Invention

The present invention relates to a control device, an electronic apparatus, a timepiece device, and a control method.

2. Background Art

An electronic apparatus, such as a timepiece in which a power generator (primary power supply) and a secondary battery (secondary power supply) such as a solar cell are mounted, operates without the need for battery replacement since the secondary battery is charged by electric power generated by the power generator. Such an electronic apparatus operates with electric power supplied from the charged secondary cell when the power generator does not generate power. Accordingly, if a state where the power generator does not generate power continues for a long time, the secondary battery continues to discharge electric power obtained by charging. If this discharge continues, an overdischarge state occurs. In the overdischarge state, the secondary battery is not immediately charged up to the power capacity, with which the electronic apparatus can operate, even if power generation of the power generator starts. For this reason, even if power generation of the power generator starts, the electronic apparatus cannot start the operation immediately.

For this reason, in order to suppress power consumption of the secondary battery with a limited power capacity in the electronic apparatus, there is a technique of performing transition to a power saving mode when a state where the power generator does not generate power is detected.

For example, in the electronic apparatus, a power generation detecting circuit detects a non-power-generation state in which the power generator does not generate power. In addition, when the non-power-generation state continues for a predetermined time or more, the electronic apparatus changes from an operating power mode, in which a normal operation is executed, to a power saving mode, in which the normal operation is stopped, so that power consumption of the secondary battery can be suppressed (refer to JP-A-2000-230988).

However, the electronic apparatus includes an input unit to which a signal from an operation switch (operator) or the like, which is an external input, is input. Moreover, in the input unit including an operation switch, the connection state of the operation switch is detected by pull-down or pull-up. For this reason, there is a problem in that even if the operation of the electronic apparatus is stopped by transition to the power saving mode, electric power is consumed in the input unit, such as an operation switch, and electric power of the secondary battery is consumed accordingly. For example, in a crown switch provided in a timepiece, a cut-off state (pushed state) or an electrically conductive state (pulled state) continues. Accordingly, a current from the power supply may always flow depending on the operation state of the crown switch.

### SUMMARY OF THE INVENTION

It is an aspect of the present application to provide a control device, an electronic apparatus, a timepiece device, and a control method capable of suppressing power consumption by reducing electric power consumed in an input unit, such as an operation switch, even if an operation of an electronic apparatus stops in a power saving mode.

According to the aspect of the application, there is provided a control device including: an input unit that pulls down or pulls up a signal input from an operating unit; a control unit that executes a predetermined operation according to the signal input through the input unit; and a power control unit that controls the control unit so as not to execute the predetermined operation and also controls the input unit so as not to pull down or pull up the signal according to a state of supplied electric power.

In addition, the control device according to the aspect of the application may further include a charging detection unit that detects whether or not a secondary power supply unit, which is charged by an electromotive force generated by a primary power supply unit, is in an uncharged state in which the secondary power supply unit is not being charged by the primary power supply unit. Moreover, when the charging detection unit detects that the secondary power supply unit is in the uncharged state, the power control unit may control the control unit so as not to execute the operation set in advance and also perform transition of the input unit to a power saving mode in which no control for pull-down or pull-up is performed.

Moreover, in the control device according to the aspect of the application, when the charging detection unit detects that the secondary power supply unit is not in the uncharged state in the power saving mode, the power control unit may control the control unit so as to execute the predetermined operation and also perform transition of the input unit to a normal operation mode in which control for pull-down or pull-up is performed.

Moreover, in the control device according to the aspect of the application, when it is determined that the secondary power supply unit is not in the uncharged state, the transition to the normal operation mode by the power control unit may be performed on the basis of an output signal output from the input unit.

Moreover, the control device according to the aspect of the application may further include a voltage detection unit that detects a voltage of the secondary power supply unit. Moreover, in a mode other than the power saving mode, the transition to the power saving mode by the power control unit may be performed only when the charging detection unit detects that the secondary power supply unit is not in the uncharged state and the detected voltage of the secondary power supply unit is equal to or lower than a predetermined threshold value.

Moreover, in the control device according to the aspect of the application, the power control unit may perform transition to the power saving mode when the secondary power supply unit is in the uncharged state and this uncharged state continues for a predetermined time or more.

Moreover, in the control device according to the aspect of the application, the power control unit may perform transition to the power saving mode when a signal according to an operation set in advance is input from the operating unit, the secondary power supply unit is in the uncharged state, and this uncharged state continues for a predetermined time or more.

Moreover, in the control device according to the aspect of the application, the control unit may include an oscillation circuit control section which generates a basic clock used for operation of the control unit by oscillation when the electric power is supplied. In addition, when the oscillation circuit control section stops oscillation of the basic clock which oscillates when the electric power is supplied, the power control unit may control the control unit so as not to execute the predetermined operation and also performs transition of the input unit to the power saving mode in which no control for pull-down or pull-up is performed.

Moreover, in the control device according to the aspect of the application, in the power saving mode, the power control unit may determine whether or not a potential difference of the electric power is equal to or higher than a potential difference, which is higher by a potential difference set in advance than a lower-limit potential difference at which a basic clock can oscillate in the oscillation circuit control section. When the potential difference of the electric power is equal to or higher than the potential difference which is higher by the potential difference set in advance than the lower-limit potential difference in the oscillation circuit control section, the power control unit may control the control unit so as to execute the predetermined operation and also perform transition of the input unit to a normal operation mode in which control for pull-down or pull-up is performed.

Moreover, in the control device according to the aspect of the application, the input unit may include: a pull-down or pull-up section which pulls down or pulls up the signal input from the operating unit; and an output control section which outputs the signal, which is output to the control unit, after setting the signal level to a High or Low level in the power saving mode.

Moreover, in the control device according to the aspect of the application, the output control section of the input unit may include an AND circuit or a NAND circuit, the signal input from the operating unit through the pull-down or pull-up section may be input to one input terminal of the AND circuit or the NAND circuit, an output of the AND circuit or the NAND circuit may be equivalent to an output of the input unit, and the power control unit may control the other input terminal of the AND circuit or the NAND circuit to have a Low level in the power saving mode.

Moreover, in the control device according to the aspect of the application, the output control section of the input unit may include a NOR circuit or an OR circuit, the signal input from the operating unit through the pull-down or pull-up section may be input to one input terminal of the NOR circuit or the OR circuit, an output of the NOR circuit or the OR circuit may be equivalent to an output of the input unit, and the power control unit may control the other input terminal of the NOR circuit or the OR circuit to have a High level in the power saving mode.

Moreover, in the control device according to the aspect of the application, the pull-down or pull-up section of the input unit may perform pull-down or pull-up using a MOSFET, and the power control unit may turn off the MOSFET in the power saving mode.

Moreover, in the control device according to the aspect of the application, the pull-down or pull-up section of the input unit may perform pull-down or pull-up using a MOSFET and a resistor connected in series to the MOSFET, and the power control unit may turn off the MOSFET in the power saving mode.

Moreover, in the control device according to the aspect of the application, the operating unit may switch between an electrically conductive state, in which both terminals of the operating unit are connected to each other, and a cut-off state, in which both the terminals are disconnected from each other, when operated.

In addition, according to another aspect of the application, there is provided an electronic apparatus including the control device described above.

In addition, according to still another aspect of the application, there is provided a timepiece device including the control device described above.

In addition, according to still another aspect of the application, a control method in a control device including an input unit that pulls down or pulls up a signal input from an operating unit and a control unit that executes a predetermined operation according to the signal input through the input unit includes controlling the control unit so as not to execute the predetermined operation and also controlling the input unit so as not to pull down or pull up the signal according to a state of supplied electric power by means of a power control unit.

According to the aspects of the application, when the operation of an electronic apparatus stops in the power saving mode, control so as not to pull down or pull up a unit connected to an input unit, such as an operation switch, is performed. As a result, since electric power consumed by pull-down or pull-up in the input unit, such as an operation switch, is reduced, power consumption can be suppressed.

### BRIEF DESCRIPTION OF THE DRAWINGS

FIG. 1 is a block diagram showing the schematic configuration of a timepiece device according to a first embodiment;

FIG. 2 is a schematic block diagram showing an example of a known operation input unit;

FIG. 3 is a schematic block diagram showing an example of an operation input unit in the first embodiment;

FIG. 4 is a flow chart showing power control processing in the first embodiment;

FIGS. 5A to 5C are graphs showing examples of the state of an output voltage of a secondary battery according to power control in the first embodiment;

FIG. 6 is a block diagram showing the schematic configuration of a timepiece device according to a second embodiment;

FIG. 7 is a schematic block diagram showing an example of an operation input unit in the second embodiment;

FIG. 8 is a table showing an input/output terminal of the operation input unit and a control state of pull-down;

FIG. 9 is a timing chart showing operations of an oscillation stop detection signal and a reset signal in a power control unit;

FIG. 10 is a block diagram showing the schematic configuration of a timepiece device according to a third embodiment;

FIG. 11 is a block diagram showing an example of the schematic configuration of a power control unit in the third embodiment;

FIG. 12 is a table in which the relationship of a current mode signal which is an internal signal of the power control unit, an input signal, and an output signal is summarized; and

FIG. 13 is a flow chart showing the flow of processing of the timepiece device according to the third embodiment.

### DETAILED DESCRIPTION OF THE INVENTION

### First Embodiment

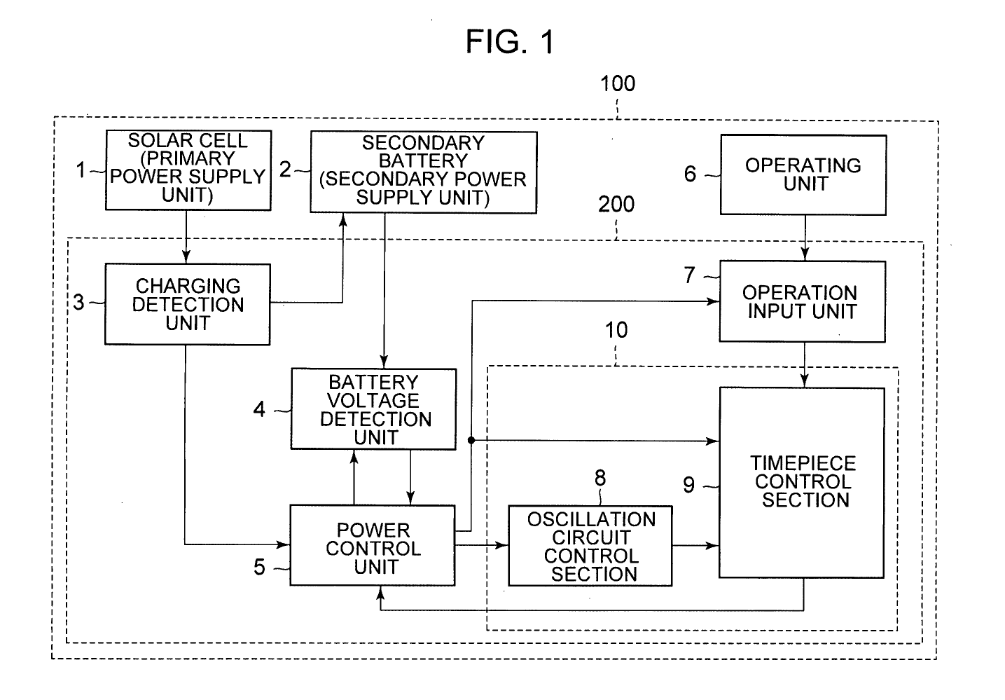

Hereinafter, a timepiece device 100 including a control device 200 according to a first embodiment of the invention will be described with reference to the accompanying drawings. FIG. 1 is a block diagram showing the schematic configuration of the timepiece device 100 according to the first embodiment of the invention.

Referring to FIG. 1, the timepiece device 100 includes a solar cell 1 (primary power supply unit), a secondary battery 2 (secondary power supply unit), an operating unit 6 (operator), and the control device 200. The control device 200 includes a charging detection unit 3, a battery voltage detection unit 4, a power control unit 5, an operation input unit 7 (input unit), and a control unit 10. In addition, the control unit 10 includes an oscillation circuit control section 8 and a timepiece control section 9. For example, the timepiece device 100 is an analog display type timepiece having a needle mechanism.

The solar cell 1 is a power generator which generates an electromotive force by converting light energy into electrical energy. Accordingly, electric power output from the solar cell 1 changes according to the amount of light input by irradiation of light, and cannot output electric power in darkness where light is not irradiated. The solar cell 1 outputs the generated electromotive force through the charging detection unit 3 to charge the secondary battery 2. In addition, the solar cell 1 supplies electric power for operating each unit of the timepiece device 100 to each unit.

The secondary battery 2 is electrically charged by the electromotive force of the solar cell 1 which is input from the solar cell 1 through the charging detection unit 3. The secondary battery 2 outputs electric power to the battery voltage detection unit 4 of the control device 200 and also supplies electric power for operating each unit of the timepiece device 100 to each unit.

The charging detection unit 3 detects whether or not the secondary battery 2 is in an uncharged state in which the secondary battery 2 is not being charged by the electromotive force generated by the solar cell 1. For example, the output voltage (output potential difference) of the solar cell 1 is compared with the output voltage (output potential difference) of the secondary battery 2. When the output voltage of the solar cell 1 is equal to or lower than the output voltage of the secondary battery 2, it is detected that the secondary battery 2 is in the uncharged state in which the secondary battery 2 is not being charged by the solar cell 1. On the other hand, when the output voltage of the solar cell 1 is higher than the output voltage of the secondary battery 2, it is detected that the secondary battery 2 is not in the uncharged state but in the charging state. The charging detection unit 3 outputs the detection result of the uncharged state or the charging state to the power control unit 5.

In addition, since the output voltage of the solar cell 1 is equal to or lower than the output voltage of the secondary battery 2 when the secondary battery 2 is in the uncharged state, the charging detection unit 3 includes a backflow preventing element which prevents the flow of a current from the secondary battery 2 to the solar cell 1.

The battery voltage detection unit 4 detects the output voltage of the secondary battery 2 according to a sampling signal for detecting a battery voltage which is input from the power control unit 5. When the battery voltage detection unit 4 detects that the output voltage of the secondary battery 2 is equal to or lower than a threshold value set in advance, the battery voltage detection unit 4 outputs the detection result to the power control unit 5.

The operating unit 6 is an operation switch operated when the user controls the timepiece device 100. The operating unit 6 outputs a signal from the operation switch to the operation input unit 7. The operating unit 6 switches between an electrically conductive state, in which both terminals of the operation switch are connected to each other, and a cut-off state, in which both the terminals are disconnected from each other, when operated, and each state continues. For example, a crown switch is in a cut-off state if pressed and in an electrically conductive state if pulled out, and the cut-off state or the electrically conductive state continues until the state of the crown switch is changed by the next operation.

The operation input unit 7 pulls down or pulls up a signal input from the operation switch of the operating unit 6 and outputs it to the timepiece control section 9. When the operation switch of the operating unit 6 is in a cut-off state, the operation input unit 7 determines the signal level by pulling down or pulling up the signal.

In addition, the operation input unit 7 pulls down or pulls up a signal on the basis of a control signal from the power control unit 5, and outputs a High-level or Low-level signal to the timepiece control section 9 when the operation input unit 7 does not pull down or pull up a signal.

The control unit 10 includes the oscillation circuit control section 8 and the timepiece control section 9, and executes a predetermined timepiece operation according to a signal which is input through the operation input unit 7 when the user operates the operation switch of the operating unit 6.

The oscillation circuit control section 8 generates a basic clock signal, which is used in checking the time, by oscillation. The oscillation circuit control section 8 supplies the generated basic clock signal to the timepiece control section 9. In addition, the oscillation circuit control section 8 includes a constant voltage circuit which supplies a power supply voltage for operating a circuit which generates a basic clock signal by oscillation. In addition, the oscillation circuit control section 8 stops the oscillation of a basic clock signal when the operation of the constant voltage circuit stops and starts the oscillation of a basic clock signal when the operation of the constant voltage circuit starts. In addition, the operation of the constant voltage circuit of the oscillation circuit control section 8 is controlled on the basis of the oscillation circuit control signal input from the power control unit 5, such that oscillation of a basic clock signal and stopping of the oscillation are controlled.

The timepiece control section 9 controls a timing operation for checking the time, a needle operation for displaying the time, and the like on the basis of the basic clock signal supplied from the oscillation circuit control section 8. When a user operates the operating unit 6, a signal input from the operating unit 6 is input to the timepiece control section 9 through the operation input unit 7. The timepiece control section 9 detects the input signal and controls a timepiece operation on the basis of the detection result. In addition, the timepiece control section 9 outputs to the power control unit 5 the information based on the detection result of the signal input from the operating unit 6, the information based on the timing operation, and the like.

For example, when a user performs an operation of pulling out a crown switch, the timepiece control section 9 performs control to stop the needle operation. Then, the user sets time by adjusting the position of the needle of the timepiece by rotating a crown switch. Then, when the user performs an operation of returning the crown switch to the pushed state, the timepiece control section 9 performs control to start the stopped needle operation on the basis of the timing operation for checking the time so that the needle operation starts from the adjusted position of the needle of the timepiece. In addition, the timepiece control section 9 stops the operation when the oscillation of the basic clock signal supplied from the oscillation circuit control section 8 is stopped.

The power control unit 5 outputs a sampling signal for detecting the output voltage of the secondary battery 2 to the battery voltage detection unit 4. In addition, a detection result of the charging detection unit 3 and a detection result of the battery voltage detection unit 4 are input to the power control unit 5. On the basis of these input detection results, the power control unit 5 outputs to the control unit 10 and the operation input unit 7 control signals for controlling each operation. In addition, according to the state of electric power supplied to the timepiece device 100, the power control unit 5 controls the control unit 10 so as not to execute a predetermined operation (operation set in advance) and performs transition of the operation input unit 7 to the power saving mode in which no control for pull-down or pull-up is performed.

Here, the state of electric power supplied to the timepiece device 100 is a state of electric power based on the detection result of the charging detection unit 3 or the detection result of the battery voltage detection unit 4. In addition, the power saving mode is a mode in which the oscillation circuit control section 8 of the control unit 10 stops oscillation of a basic clock signal and the operation of the timepiece control section 9 is stopped and a signal input from the operating unit 6 is not pulled down or pulled up in the operation input unit 7.

The power control unit 5 determines whether or not the secondary battery 2 is in the uncharged state, in which the secondary battery 2 is not being charged by the electromotive force generated by the solar cell 1, on the basis of the input detection result of the charging detection unit 3. In addition, the power control unit 5 determines whether or not the output voltage of the secondary battery 2 is equal to or lower than the threshold value set in advance on the basis of the detection result of the battery voltage detection unit 4.

For example, the power control unit 5 performs transition of the timepiece device 100 to the power saving mode on the basis of any of the following conditions.

(1) The power control unit 5 performs transition of the timepiece device 100 to the power saving mode when the secondary battery 2 is in the uncharged state.

(2) The power control unit 5 performs transition of the timepiece device 100 to the power saving mode when the secondary battery 2 is in the uncharged state and the output voltage of the secondary battery 2 is equal to or lower than the threshold value set in advance.

(3) The power control unit 5 performs transition of the timepiece device 100 to the power saving mode when the secondary battery 2 is in the uncharged state and the uncharged state of the secondary battery 2 continues for a period set in advance or more.

(4) The power control unit 5 performs transition of the timepiece device 100 to the power saving mode when a signal according to the operation set in advance is input from the operating unit 6, the secondary battery 2 is in the uncharged state, and this uncharged state of the secondary battery 2 continues for a period set in advance or more.

Here, the state where a signal according to the operation set in advance is input from the operating unit 6 is a state where a crown switch is pulled out, for example.

In addition, when the timepiece device 100 is in the power saving mode, the power control unit 5 determines whether or not the secondary battery 2 is in the uncharged state on the basis of the detection result of the charging detection unit 3. When the secondary battery 2 is not in the uncharged state but in the charging state, the power control unit 5 controls the control unit 10 to execute a predetermined operation (operation set in advance) and performs transition of the operation input unit 7 to the normal operation mode in which control for pull-down or pull-up is performed. Here, the normal operation mode is a mode in which the oscillation circuit control section 8 oscillates and outputs a basic clock signal and the timepiece control section 9 operates and a signal input from the operating unit 6 is pulled down or pulled up in the operation input unit 7.

In addition, when the power control unit 5 determines whether or not the output voltage of the secondary battery 2 is equal to or lower than the threshold value set in advance on the basis of the detection result of the battery voltage detection unit 4, the threshold value set in advance is a higher voltage than the lower-limit voltage at which the timepiece control section 9 can execute a needle operation.

In addition, in the case of measuring the elapsed time of the uncharged state in the above-described conditions for transition to the power saving mode, the power control unit 5 may start the measurement from a point of time when it is determined that the secondary battery 2 is in the uncharged state on the basis of the detection result of the charging detection unit 3. Alternatively, the power control unit 5 may output a result of determination of the uncharged state based on the detection result of the charging detection unit 3 to the timepiece control section 9 so that the timepiece control section 9 performs the measurement.

In addition, when determination is made by comparing the elapsed time of the uncharged state with a predetermined time, the power control unit 5 may perform the determination by comparison with the predetermined time on the basis of a result of the elapsed time measured by the power control unit 5 or the timepiece control section 9. Alternatively, the timepiece control section 9 may perform the determination by comparison with a predetermined time on the basis of a result of the elapsed time measured by the power control unit 5 or the timepiece control section 9.

In addition, when the state where a signal according to an operation set in advance is input from the operating unit 6 is set as the conditions for transition to the power saving mode, the timepiece control section 9 which detects the signal input from the operation input unit 7 may perform the determination on the basis of the detection result. Alternatively, the timepiece control section 9 which detects the signal input from the operation input unit 7 outputs the detection result to the power control unit 5. Then, the power control unit 5 may perform the determination on the basis of the input detection result.

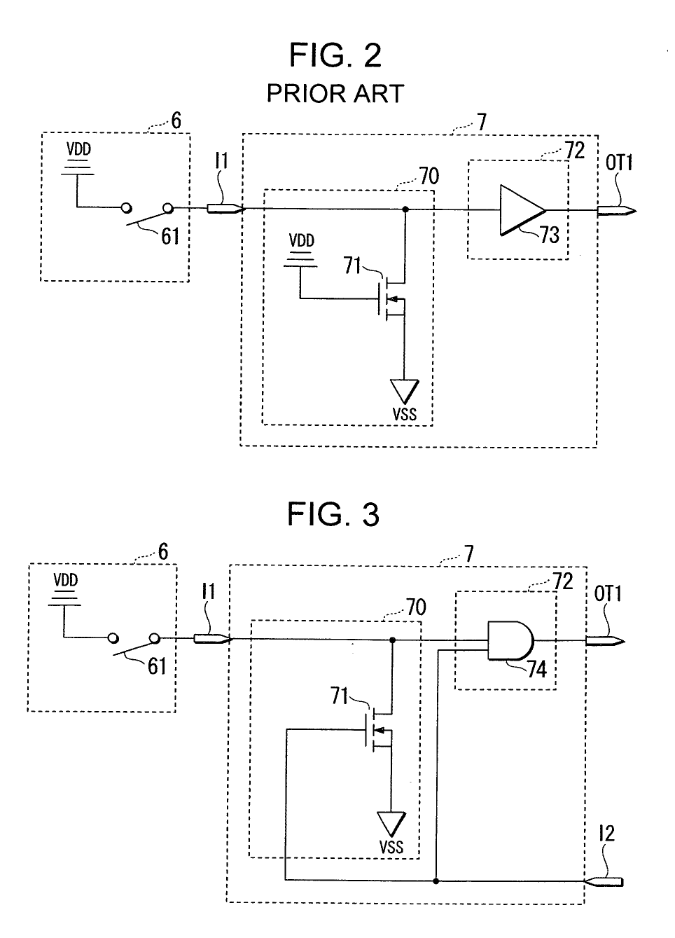

Next, the operating unit 6 and the operation input unit 7 will be described with reference to FIGS. 2 and 3.

FIG. 2 is a schematic block diagram showing an example of the known operation input unit 7 to which the first embodiment is not applied. FIG. 3 is a schematic block diagram showing an example of the operation input unit 7 in the first embodiment. Moreover, in FIGS. 2 and 3, a power supply VSS is a negative power supply and a power supply VDD is a ground GND. In addition, a voltage (potential difference) between the power supply VSS and the power supply VDD is supplied to the operating unit 6 and the operation input unit 7.

The operating unit 6 shown in FIGS. 2 and 3 includes a switch 61. One connection terminal of the switch 61 is connected to the power supply VDD, and the other connection terminal is connected to a terminal I1 of the operation input unit 7. Moreover, the switch 61 switches between an electrically conductive state, in which both connection terminals of the switch 61 are connected to each other, and a cut-off state, in which both connection terminals of the switch 61 are disconnected from each other, when operated, and each state continues.

Next, the operation input unit 7 shown in FIG. 2 will be described.

The operation input unit 7 includes a pull-down or pull-up section 70 and an output control section 72. The pull-down or pull-up section 70 pulls down or pulls up a signal input from the operating unit 6. The pull-down or pull-up section 70 shown in FIG. 2 has a form of pulling down a signal input from the operating unit 6.

The signal input from the terminal I1 of the operation input unit 7 is input to the output control section 72 through the pull-down or pull-up section 70 and is then output from the output control section 72 to a terminal OT1. In addition, the pull-down or pull-up section 70 includes an NMOSFET (N-channel metal oxide semiconductor field effect transistor) 71 for pull-down, and the output control section 72 includes a buffer 73.

The input terminal I1 is connected to an input terminal of the buffer 73, and an output terminal of the buffer 73 is connected to the terminal OT1. In addition, a drain terminal of the NMOSFET 71 is connected to a connection point between the terminal I1 and the input terminal of the buffer 73, its source terminal is connected to the power supply VSS, and its gate terminal is connected to the power supply VDD.

The NMOSFET 71 is turned on when a voltage between the power supply VDD and the power supply VSS is applied between the gate and the source. Accordingly, the NMOSFET 71 is in an electrically conductive state with ON resistance between the drain and the source, and a current corresponding to the ON resistance flows to the power supply VSS to be pulled down.

When the switch 61 is in the electrically conductive state, the voltage of the power supply VDD is input to the terminal I1, and the voltage of the power supply VDD is output from the terminal OT1 through the buffer 73 after pull-down by the NMOSFET 71. When the switch 61 is in the cut-off state, the signal level of a signal input from the terminal I1 is not fixed. Accordingly, the signal input from the terminal I1 is pulled down by the NMOSFET 71 to have a voltage of the power supply VSS. Then, the signal is output from the terminal OT1 through the buffer 73.

Next, the operation input unit 7 of the first embodiment shown in FIG. 3 will be described. Moreover, sections in FIG. 3 corresponding to the sections in FIG. 2 are denoted by the same reference numerals, and the explanation will be appropriately omitted.

Similar to the operation input unit 7 shown in FIG. 2, the operation input unit 7 shown in FIG. 3 includes a pull-down or pull-up section 70 and an output control section 72. A gate terminal of a pull-down NMOSFET 71 provided in the pull-down or pull-up section 70 is connected to a terminal I2. In addition, the output control section 72 includes an AND circuit 74. One input terminal of the AND circuit 74 is connected to a connection point between the terminal I1 and a drain terminal of the NMOSFET 71, and the other input terminal is connected to the terminal I2. In addition, an output terminal of the AND circuit 74 is connected to the terminal OT1.

ON/OFF switching of the NMOSFET 71 shown in FIG. 3 is controlled by the signal level input to the terminal I2.

In addition, when NMOSFET 71 is turned off and the switch 61 is in the cut-off state, the signal level of a signal input from the terminal I1 is not fixed. If the signal with the unfixed signal level is output from the terminal OT1, a through current may be generated in a circuit at the output destination when the output signal has an intermediate potential of the power supply VDD and the power supply VSS, and this may damage the circuit. Therefore, in a state where the NMOSFET 71 is turned off, control is performed such that a Low-level signal is output from the terminal OT1 by making the Low-level signal being input from the terminal I2 to the AND circuit 74.

For example, the power control unit 5 outputs a Low-level signal in the power saving mode and outputs a High-level signal in the normal operation mode. The output signal is input to the terminal I2 of the operation input unit 7. In the power saving mode, a Low-level signal is input to the terminal I2 to turn off the NMOSFET 71 so that pull-down does not occur and the Low-level signal is also input to the AND circuit 74 so that the Low-level signal is output from the terminal OT1. In addition, in the normal operation mode, a High-level signal is input to the terminal I2 to turn on the NMOSFET 71 so that pull-down occurs and the High-level signal is also input to the AND circuit 74. As a result, the signal input from the terminal I1 is pulled down by the NMOSFET 71, and the pull-down signal is output from the terminal OT1.

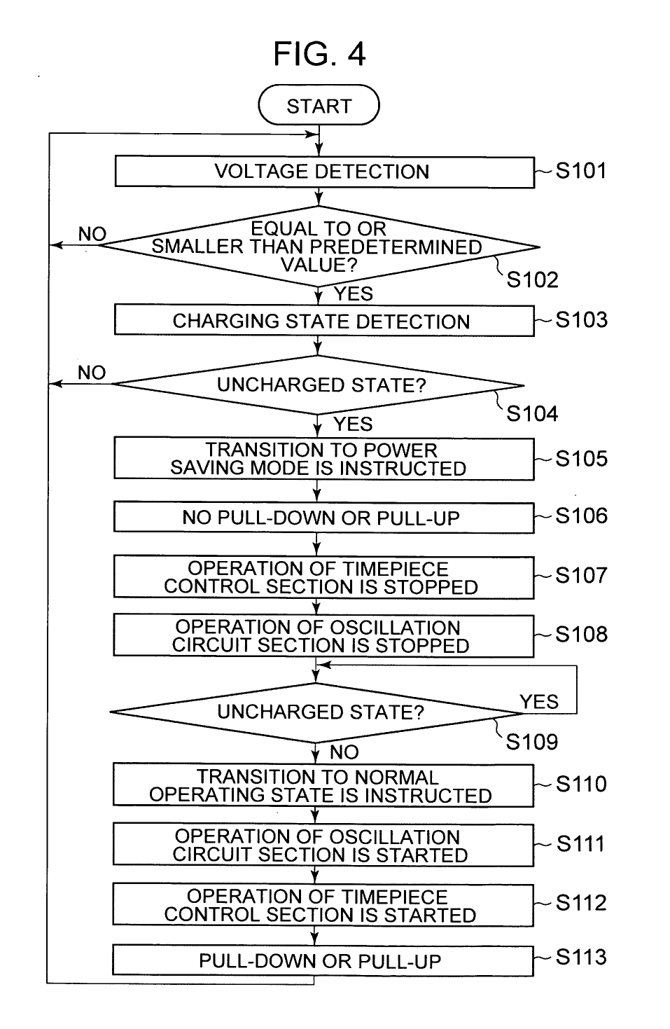

Next, an operation in the first embodiment will be described. FIG. 4 is a flow chart showing an example of the power control processing in the first embodiment. In addition, FIG. 4 shows the processing in which the power control unit 5 performs transition of the timepiece device 100 to the power saving mode when the detection result of the charging detection unit 3 is an uncharged state and the output voltage of the secondary battery 2 is equal to or lower than the threshold value set in advance.

Hereinafter, the power control processing of the timepiece device 100 will be described using the flow chart shown in FIG. 4.

First, the power control unit 5 outputs a sampling signal for detecting the battery voltage to the battery voltage detection unit 4 at fixed intervals in order to make the battery voltage detection unit 4 detect the output voltage of the secondary battery 2. The battery voltage detection unit 4 detects the output voltage of the secondary battery 2 according to the sampling signal input from the power control unit 5. When the battery voltage detection unit 4 detects that the output voltage of the secondary battery 2 is equal to or lower than a threshold value set in advance, the battery voltage detection unit 4 outputs the detection result to the power control unit 5 (step S101).

Then, the power control unit 5 determines whether or not the output voltage of the secondary battery 2 is equal to or lower than the predetermined value (threshold value set in advance) on the basis of the detection result of the battery voltage detection unit 4 (step S102). When it is determined that the output voltage of the secondary battery 2 is equal to or lower than the predetermined value (threshold value set in advance) in step S102 (YES), the process proceeds to step S103. In addition, when it is determined that the output voltage of the secondary battery 2 is higher than the predetermined value (threshold value set in advance) in step S102 (NO), the process returns to step S101.

Then, in step S103, the power control unit 5 determines whether or not the secondary battery 2 is in the uncharged state, in which the secondary battery 2 is not being charged, on the basis of the detection result of the charging detection unit 3.

The charging detection unit 3 detects whether or not the secondary battery 2 is in the uncharged state in which the secondary battery 2 is not being charged by the electromotive force generated by the solar cell 1. For example, the charging detection unit 3 compares the output voltage (output potential difference) of the solar cell 1 with the output voltage (output potential difference) of the secondary battery 2 and detects that the secondary battery 2 is in the uncharged state, in which the secondary battery 2 is not being charged by the solar cell 1, when the output voltage of the solar cell 1 is equal to or lower than the output voltage of the secondary battery 2. In addition, when the output voltage of the solar cell 1 is higher than the output voltage of the secondary battery 2, the charging detection unit 3 detects that the secondary battery 2 is not in the uncharged state but in the charging state.

Then, the power control unit 5 determines whether or not the secondary battery 2 is in the uncharged state, in which the secondary battery 2 is not being charged, on the basis of the detection result of the charging detection unit 3 (step S104). When it is determined that the secondary battery 2 is in the uncharged state in which the secondary battery 2 is not being charged in step S104 (YES), the process proceeds to step S105. On the other hand, when it is determined that the secondary battery 2 is not in the uncharged state but in the charging state (NO), the process returns to step S101.

Then, when it is determined that the secondary battery 2 is in the uncharged state in which the secondary battery 2 is not being charged in step S104 (YES), the power control unit 5 outputs a control signal for transition of the timepiece device 100 to the power saving mode to each of the operation input unit 7 and the control unit 10 (step S105).

Then, in step S106, the operation input unit 7 is controlled according to the control signal for transition to the power saving mode, which is output from the power control unit 5, such that the signal input from the operating unit 6 is not pulled down or pulled up.

In addition, according to the control signal for transition to the power saving mode which is output from the power control unit 5, a High-level or Low-level signal is output from the operation input unit 7 to the timepiece control section 9. As a result, since no signal is pulled down or pulled up in the operation input unit 7, power consumption is reduced.

Then, according to the control signal for transition to the power saving mode which is output from the power control unit 5, control for stopping the operation of each section of the control unit 10 is executed.

In step S107, the operation of the timepiece control section 9 is stopped according to the control signal for transition to the power saving mode which is output from the power control unit 5. For example, in the timepiece control section 9, a needle operation for displaying the time is stopped according to the input control signal for transition to the power saving mode.

Then, in step S108, oscillation of a basic clock of the oscillation circuit control section 8 is stopped according to the control signal for transition to the power saving mode which is output from the power control unit 5. Since the operation of the constant voltage circuit is stopped according to the input control signal for transition to the power saving mode in the oscillation circuit control section 8, the oscillation of a basic clock signal is stopped. In addition, since the oscillation of the basic clock signal of the oscillation circuit control section 8 is stopped, a timing operation of the timepiece control section 9 is stopped. As a result, since the operations of the timepiece control section 9 and the oscillation circuit control section 8 are stopped in the timepiece device 100, electric power necessary for operating each of the timepiece control section 9 and the oscillation circuit control section 8 is reduced.

Thus, the power control unit 5 performs transition of the timepiece device 100 to the power saving mode by stopping the operations of the timepiece control section 9 and the oscillation circuit control section 8 while making the signal input from the operating unit 6 not be pulled down or pulled up in the operation input unit 7.

Then, the power control unit 5 determines whether or not the secondary battery 2 is in the uncharged state, in which the secondary battery 2 is not being charged, on the basis of the detection result of the charging detection unit 3 (step S109). When it is determined that the secondary battery 2 is not in the uncharged state but in the charging state in step S109 (NO), the process proceeds to step S110. In addition, when it is determined that the secondary battery 2 is not in the charging state but in the uncharged state (YES), the processing in step S109 is repeated so that the power saving mode is continued.

Then, when it is determined that the secondary battery 2 is not in the uncharged state but in the charging state in step S109 (NO), the power control unit 5 outputs a control signal for transition of the timepiece device 100 to the normal operation mode to each of the operation input unit 7 and the control unit 10 (step S110).

Then, in step S111, a basic clock of the oscillation circuit control section 8 is made to oscillate according to the control signal for transition to the normal operation mode which is output from the power control unit 5. Since the operation of the constant voltage circuit is started according to the input control signal for transition to the normal operation mode in the oscillation circuit control section 8, the oscillation of a basic clock signal is started.

Then, in step S112, the operation of the timepiece control section 9 is started according to the control signal for transition to the normal operation mode which is output from the power control unit 5. For example, in the timepiece control section 9, a needle operation for displaying the time is started according to the input control signal for transition to the normal operation mode.

Then, in step S113, the operation input unit 7 is controlled according to the control signal for transition to the power saving mode, which is output from the power control unit 5, such that the signal input from the operating unit 6 is pulled down or pulled up.

In addition, a signal for pulling down or pulling up the signal input from the operating unit 6 is output from the operation input unit 7 to the timepiece control section 9 according to the control signal for transition to the power saving mode which is output from the power control unit 5.

Then, the process returns to step S101 to execute the processing in steps S101 to S113.

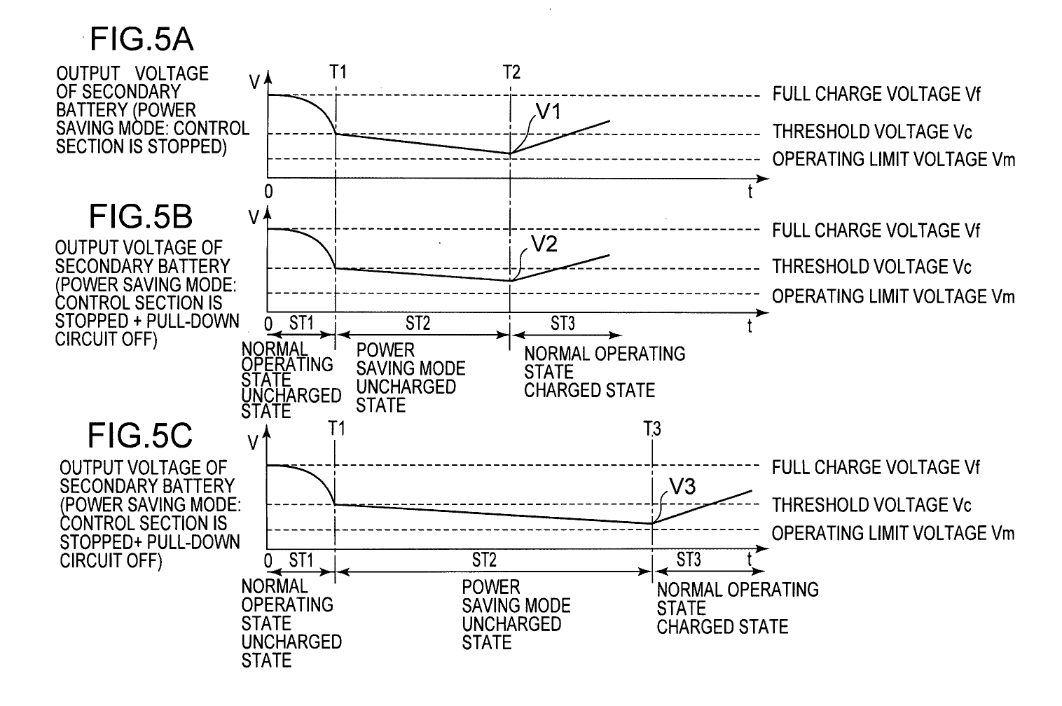

FIGS. 5A to 5C are graphs showing examples of the state of an output voltage of the secondary battery 2 according to power control in the first embodiment. In the graphs shown in FIGS. 5A to 5C, the horizontal axis indicates time t and the vertical axis indicates a voltage V.

FIG. 5A shows an output voltage of the secondary battery 2 when the invention is not applied, that is, when only the control unit 10 is stopped (the oscillation circuit control section 8 and the timepiece control section 9 are stopped) in the power saving mode. In addition, FIGS. 5B and 5C show an output voltage of the secondary battery 2, when the control unit 10 is stopped and control is made such that pull-down or pull-up in the operation input unit 7 is not performed, in the power saving mode. In addition, the graphs shown in FIGS. 5A to 5C show examples of transition of the timepiece device 100 to the power saving mode when the detection result of the charging detection unit 3 is an uncharged state and the output voltage of the secondary battery 2 is equal to or lower than the threshold value set in advance.

First, FIGS. 5A and 5B will be described.

In a period ST1 of time 0 to time T1, a normal operation mode continues. In addition, in the period ST1, the solar cell 1 cannot generate electric power since the solar cell 1 is not irradiated with light, and the secondary battery 2 is in the uncharged state. In the period ST1, there is no difference in power consumption in the operating states shown in FIGS. 5A and 5B. Accordingly, in the secondary battery 2 shown in FIGS. 5A and 5B, electric power is consumed similarly and the output voltage of the secondary battery 2 drops similarly.

At time T1, the output voltage of the secondary battery 2 shown in FIGS. 5A and 5B is a threshold voltage Vc which is set in advance so that the battery voltage detection unit 4 can detect it. Therefore, the battery voltage detection unit 4 detects that the output voltage of the secondary battery 2 is equal to or lower than the threshold voltage Vc set in advance. Since the output voltage of the secondary battery 2 is equal to or lower than the threshold voltage Vc set in advance and the secondary battery 2 is in the uncharged state, the power control unit 5 performs transition from the normal operation mode to the power saving mode.

In a period ST2 of time T1 to time T2, a power saving mode continues, and the secondary battery 2 is in the uncharged state. Since the power saving mode continues in the period ST2, power consumption in the secondary battery 2 is reduced compared with that in the period ST1, and the amount of drop in the output voltage of the secondary battery 2 with time is small compared with that in the period ST1. Moreover, in the period ST2, there is a difference in power consumption in the power saving mode shown in FIGS. 5A and 5B. Compared with FIG. 5A, in the power saving mode shown in FIG. 5B, control is made such that pull-down or pull-up in the operation input unit 7 is not performed. Accordingly, electric power consumed in the operation input unit 7 is further reduced. Therefore, at time T2, the amount of drop in the output voltage V2 of the secondary battery 2 shown in FIG. 5B is smaller than that in the output voltage V1 of the secondary battery 2 shown in FIG. 5A. As a result, the voltage V1 is smaller than the voltage V2.

Then, at time T2, the solar cell 1 is irradiated with light to start power generation. Accordingly, the secondary battery 2 changes from the uncharged state to the charging state. If it is detected that the charging detection unit 3 is not in the uncharged state, the power control unit 5 performs transition from the power saving mode to the normal operation mode on the basis of the detection result. In a period ST3 after time T2, a normal operation mode continues and the secondary battery 2 is in the charging state. Since the secondary battery 2 is in the charging state in the period ST3, the output voltage of the secondary battery 2 is charged as time elapses and rises until it reaches a full charge voltage Vf.

Here, a normal operation can be started immediately after transition from the power saving mode in the period ST2 to the charging state at time T2. This is because the output voltage of the secondary battery 2 does not drop below the operating limit voltage Vm and accordingly, this in not an overdischarge state. That is, transition to the power saving mode is performed when the output voltage of the secondary battery 2 becomes equal to or lower than the threshold voltage Vc which is set in advance and is a higher voltage than the operating limit voltage Vm (time T1) and power consumption in the secondary battery 2 is reduced in the power saving mode in the period ST2, so that the secondary battery 2 is kept from being in the overdischarge state.

Moreover, as the threshold voltage Vc increases, a time for which a normal operation can continue with the secondary battery 2 is reduced. For this reason, it is not useful for a user to set the threshold voltage Vc too high. Therefore, reducing the power consumption in the secondary battery 2 further in the power saving mode is effective in making the secondary battery 2 not be overdischarged.

At time T2, the relationship between the output voltage V1 of the secondary battery 2 shown in FIG. 5A and the output voltage V2 of the secondary battery 2 shown in FIG. 5B is voltage V1<voltage V2. This means that elapsed time until the output voltage of the secondary battery 2 reaches the operating limit voltage Vm in FIG. 5B is longer than that in FIG. 5A.

Next, FIG. 5C will be described. FIG. 5C shows the output voltage of the secondary battery 2 when the period ST2 shown in FIG. 5B continues even after time T2. Although the output voltage of the secondary battery 2 shown in FIG. 5B is the voltage V2 at time T2, the output voltage of the secondary battery 2 decreases from the voltage V2 when the period ST2 continues even after time T2. FIG. 5C shows the output voltage of the secondary battery 2 when the period ST2 continues until the output voltage of the secondary battery 2 shown in FIG. 5B drops to the voltage V1. An output voltage V3 of the secondary battery 2 at time T3 shown in FIG. 5C is equal to the output voltage V1 of the secondary battery 2 at time T2 shown in FIG. 5A. Therefore, FIG. 5C shows that a period until the output voltage of the secondary battery 2 decreases to the operating limit voltage Vm extends when the period ST2 continues for a long time, compared with that in FIG. 5A.

Thus, according to the first embodiment, in the power saving mode, the operation of the timepiece device 100 stops and control so as not to pull down or pull up the NMOSFET 71 connected to the input unit, such as an operation switch, is performed. As a result, since electric power consumed by pull-down or pull-up in the input unit, such as an operation switch, is reduced, power consumption can be suppressed.

In addition, although an example in which the output control section 72 of the operation input unit 7 includes the AND circuit 74 is shown in FIG. 3 in the first embodiment, the AND circuit 74 may be replaced with a NAND circuit. For example, when the output control section 72 includes a NAND circuit, a signal input from the operating unit 6 through the pull-down or pull-up section 70 may be input to one input terminal of the NAND circuit and a control signal from the power control unit 5 may be input to the other input terminal of the NAND circuit. Moreover, in the power saving mode, the power control unit 5 may control a control signal to have a Low level so that the output signal of the NAND circuit, that is, a signal output from the operation input unit 7 to the control unit 10 changes to a High level, thereby preventing the signal level from being unfixed.

In addition, the output control section 72 of the operation input unit 7 may include an OR circuit, a NOR circuit, or a circuit obtained by combining various kinds of logic circuits as well as the AND circuit and the NAND circuit. In addition, in the power saving mode, the power control unit 5 may input a Low-level or High-level control signal corresponding to each of the various kinds of logic circuits, which are provided in the output control section 72, to change the signal output from the operation input unit 7 to the control unit 10 to the Low level or the High level, thereby preventing the signal level from being unfixed.

In addition, in the first embodiment, an example in which the pull-down or pull-up section 70 of the operation input unit 7 includes a pull-down or pull-up MOSFET is shown in FIG. 3. Instead of this, the pull-down or pull-up section 70 of the operation input unit 7 may include a pull-down or pull-up resistor and a transistor circuit which is connected in series to the resistor and performs switching so as to be electrically connected to or disconnected from the resistor, for example. In this case, the power control unit 5 may control pull-down or pull-up according to control of ON (conduction) and OFF (cut-off) of the transistor circuit.

In addition, although the analog display type timepiece has been described as an example of the timepiece device 100 according to the first embodiment, a digital display type timepiece may also be used. In addition, although the timepiece device 100 according to the first embodiment has been described, an electronic apparatus which executes a predetermined operation (operation set in advance) with a power supply voltage supplied from the solar cell 1 and the secondary battery 2 may be used instead of the timepiece device 100.

### Second Embodiment

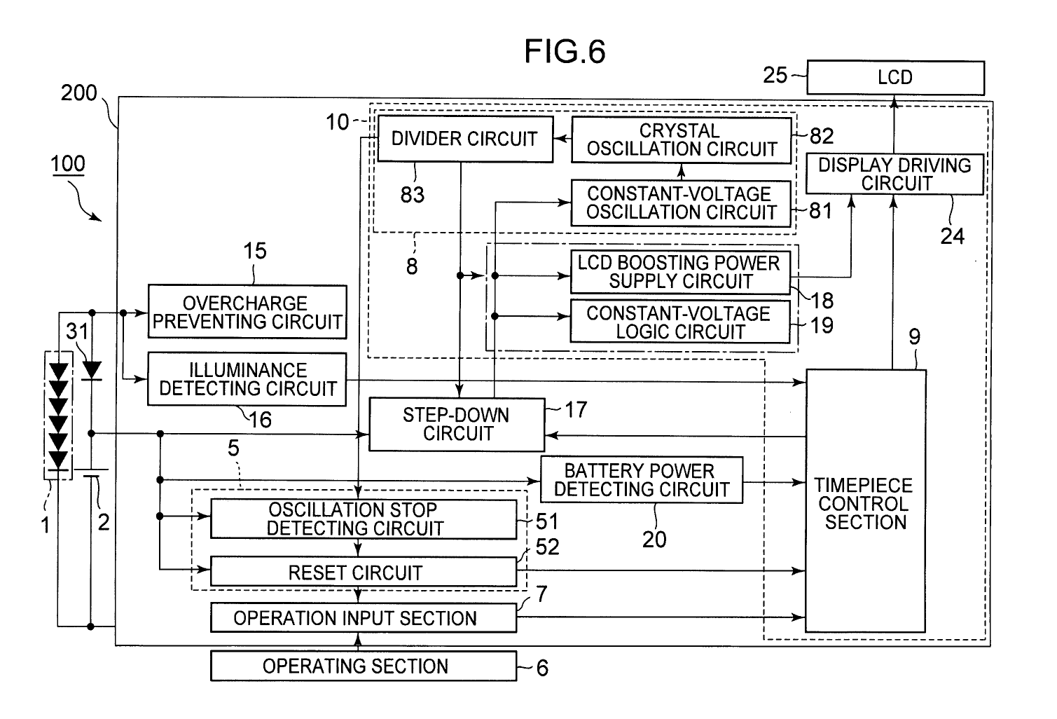

Hereinafter, a timepiece device 100 including a control device 200 according to a second embodiment of the invention will be described with reference to the accompanying drawings. FIG. 6 is a block diagram showing the schematic configuration of the timepiece device 100 according to the second embodiment of the invention. In the second embodiment, the control device 200 detects stopping of oscillation of a basic clock used for operation of the control unit 10 and the voltage (potential difference) of supplied electric power and controls pull-down or pull-up in the operation input unit 7 on the basis of the detection result. In addition, sections in FIG. 6 corresponding to the sections in FIG. 1 are denoted by the same reference numerals, and the explanation will be appropriately omitted.

Referring to FIG. 6, the timepiece device 100 includes a solar cell 1 (primary power supply unit), a secondary battery 2 (secondary power supply unit), a backflow preventing circuit 31, an operating unit 6 (operator), an LCD (Liquid Crystal Display) 25, and a control device 200. For example, the timepiece device 100 is a digital display type timepiece which displays time on the LCD 25. In addition, the backflow preventing circuit 31 prevents electrical connection between the solar cell 1 and the secondary battery 2 in the uncharged state where the output voltage (output potential difference) of the solar cell 1 is equal to or lower than the output voltage (output potential difference) of the secondary battery 2. In this way, the backflow preventing circuit 31 prevents a backflow of a current from the secondary battery 2 to the solar cell 1. In addition, the backflow preventing circuit 31 corresponds to the backflow preventing element provided in the charging detection unit 3 shown in FIG. 1.

The control device 200 includes a power control unit 5, an operation input unit 7 (input unit), a control unit 10, an overcharge preventing circuit 15, an illuminance detecting circuit 16, a step-down circuit 17, and a battery power detecting circuit 20. The overcharge preventing circuit 15 is a circuit which prevents overcharging from the solar cell 1 to the secondary battery 2, and stops charging from the solar cell 1 when the output voltage of the secondary battery 2 becomes equal to or higher than a voltage set in advance. The illuminance detecting circuit 16 detects the illuminance of light emitted to the solar cell 1 and outputs a signal indicating the detected illuminance to the control unit 10. The step-down circuit 17 steps down the output voltage of the secondary battery 2 and supplies it to each power supply circuit which supplies electric power to each section of the timepiece device 100. The battery power detecting circuit 20 detects the output voltage of the secondary battery 2 and outputs a signal indicating the battery power to the control unit 10.

The control unit 10 includes an oscillation circuit control section 8, an LCD boosting power supply circuit 18, a constant-voltage logic circuit 19, a timepiece control section 9, and a display driving circuit 24.

The oscillation circuit control section 8 includes a constant-voltage oscillation circuit 81, a crystal oscillation circuit 82, and a frequency divider circuit 83. The constant-voltage oscillation circuit 81 generates constant-voltage power from electric power supplied from the step-down circuit 17 and supplies it to the crystal oscillation circuit 82. The oscillation circuit control section 8 generates a basic clock signal, which is used in checking the time, by oscillation using electric power supplied from the constant-voltage oscillation circuit 81. That is, the oscillation circuit control section 8 stops the oscillation of a basic clock signal when the supply of electric power from the constant-voltage oscillation circuit 81 is stopped and starts the oscillation of a basic clock signal when the supply of electric power from the constant-voltage oscillation circuit 81 is started.

In addition, the oscillation circuit control section 8 outputs the generated basic clock signal to the timepiece control section 9. In addition, the frequency divider circuit 83 performs frequency division of the basic clock signal generated by the crystal oscillation circuit 82 and outputs the frequency-divided signal. The clock signal frequency-divided by the frequency divider circuit 83 is input, as a clock signal for generating each output voltage, to the step-down circuit 17, the LCD boosting power supply circuit 18, and the constant-voltage logic circuit 19. In addition, the frequency-divided clock signal is input to the power control unit 5.

The LCD boosting power supply circuit 18 generates a voltage, which is required for driving the LCD 25 and the display driving circuit 24, from electric power supplied from the step-down circuit 17. Then, the LCD boosting power supply circuit 18 supplies electric power of the generated voltage to the LCD 25 and the display driving circuit 24. The constant-voltage logic circuit 19 generates a voltage of the logic system, which is required mainly for driving of the timepiece control section 9, from electric power supplied from the step-down circuit 17. Then, the constant-voltage logic circuit 19 supplies electric power of the generated voltage to the timepiece control section 9 and other logic circuits.

The display driving circuit 24 is a driving circuit which drives a display operation of the LCD 25. The timepiece control section 9 displays the time, which is checked on the basis of the basic clock signal supplied from the oscillation circuit control section 8, on the LCD 25 through the display driving circuit 24. In addition, a signal indicating the illuminance detected by the illuminance detecting circuit 16 is input to the timepiece control section 9. For example, the timepiece control section 9 changes the content of display or the display brightness of the LCD 25 on the basis of the detected illuminance. In addition, the timepiece control section 9 displays the content showing battery power of the secondary battery 2 on the LCD 25 on the basis of a signal, which indicates the battery power input from the battery power detecting circuit 20, through the display driving circuit 24.

The power control unit 5 includes an oscillation stop detecting circuit 51 and a reset circuit 52. A clock signal frequency-divided by the frequency divider circuit 83 of the oscillation circuit control section 8 is input to the oscillation stop detecting circuit 51. Then, the oscillation stop detecting circuit 51 detects whether or not the oscillation circuit control section 8 has stopped an oscillation operation on the basis of the input clock signal. For example, when it is detected that the oscillation circuit control section 8 has stopped the oscillation operation, the oscillation stop detecting circuit 51 controls an oscillation stop detection signal to have a Low level and outputs it to the reset circuit 52. On the other hand, when it is detected that the oscillation circuit control section 8 does not stop the oscillation operation, the oscillation stop detecting circuit 51 controls an oscillation stop detection signal to have a High level and outputs it to the reset circuit 52.

The reset circuit 52 controls a reset signal on the basis of the output voltage of the oscillation stop detecting circuit 51 and the secondary battery 2. For example, the reset circuit 52 controls a reset signal to have a High level (resetting) when the oscillation stop detection signal input from the oscillation stop detecting circuit 51 changes to a Low level. Moreover, in a state where the reset signal is controlled to have a High level, the reset circuit 52 controls the reset signal to change from a High level to a Low level when the oscillation stop detection signal is at a High level and the output voltage of the secondary battery 2 becomes equal to or higher than a predetermined threshold value (second threshold value) (resetting cancel). Here, the predetermined threshold value (second threshold value) is a voltage (potential difference) which is higher by a voltage (potential difference) set in advance than the lower-limit voltage (potential difference) at which the oscillation circuit control section 8 can oscillate a basic clock.

In addition, the power control unit 5 outputs the reset signal controlled by this reset circuit 52 to the timepiece control section 9 and the operation input unit 7. That is, the power control unit 5 outputs the High-level reset signal from the reset circuit 52 to the timepiece control section 9 and the operation input unit 7 for transition of the timepiece device 100 to the power saving mode. On the other hand, the power control unit 5 outputs the Low-level reset signal from the reset circuit 52 to the timepiece control section 9 and the operation input unit 7 for transition of the timepiece device 100 from the power saving mode to the normal operation mode.

When the input reset signal is at a Low level, the timepiece control section 9 executes an operation of controlling the timepiece device 100 which is not reset (normal operation mode). On the other hand, when the input reset signal is at a High level, the timepiece control section 9 is reset to stop its operation (power saving mode). In addition, when the input reset signal is at a Low level, the operation input unit 7 performs control to pull down or pull up the signal input from the operating unit 6 (normal operation mode). On the other hand, when the input reset signal is at a High level, the operation input unit 7 performs control so as not to pull down or pull up the signal input from the operating unit 6 (power saving mode).

That is, when the oscillation of the basic clock is stopped by the oscillation circuit control section 8, the power control unit 5 controls the timepiece control section 9 of the control unit 10 so as not to execute a predetermined operation (operation set in advance) and performs transition of the operation input unit 7 to the power saving mode in which the signal input from the operating unit 6 is controlled so as not to be pulled down or pulled up. In addition, when the timepiece device 100 is in a power saving mode, the power control unit 5 determines whether or not the output voltage of the secondary battery 2 is equal to or higher than the second threshold value. When it is determined that the output voltage of the secondary battery 2 is equal to or higher than the second threshold value, the power control unit 5 controls the timepiece control section 9 of the control unit 10 to execute a predetermined operation (operation set in advance) and performs transition of the operation input unit 7 to the normal operation mode in which the signal input from the operating unit 6 is controlled to be pulled down or pulled up.

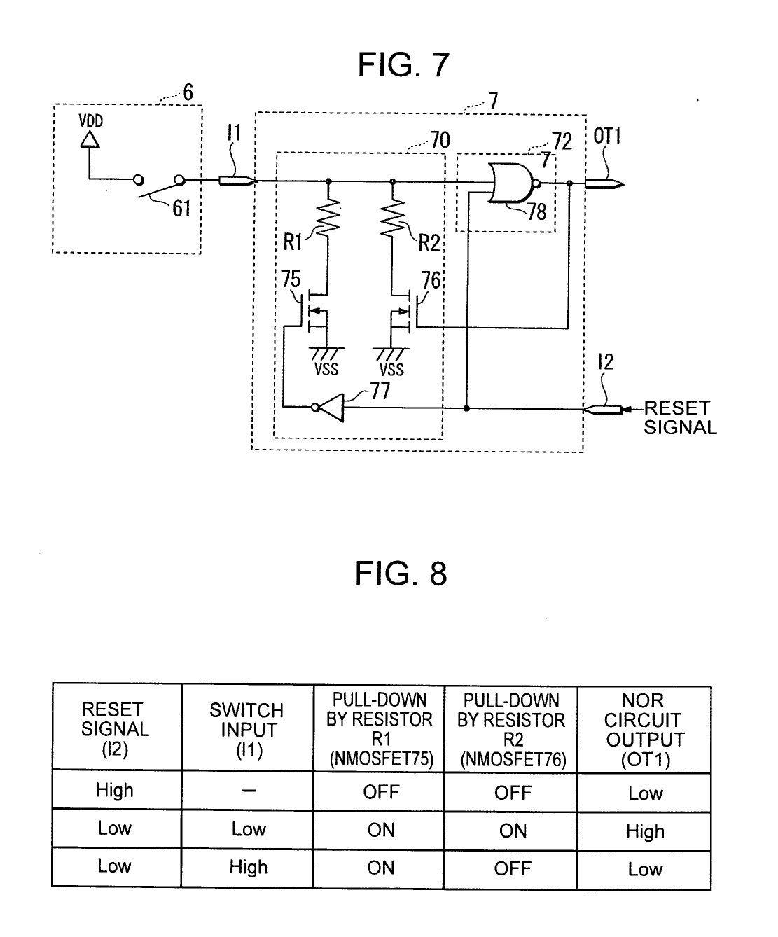

Next, details of the operation input unit 7 of the second embodiment will be described using FIG. 7. FIG. 7 is a schematic block diagram showing an example of the operation input unit 7 in the second embodiment. Moreover, in FIG. 7, a power supply VDD is a positive power supply and a power supply VSS is a ground GND. In addition, a voltage (potential difference) between the power supply VDD and the power supply VSS is supplied to the operating unit 6 and the operation input unit 7. In addition, sections in FIG. 7 corresponding to the sections in FIGS. 2 and 3 are denoted by the same reference numerals, and the explanation will be appropriately omitted.

Similar to the operation input unit 7 shown in FIG. 3, the operation input unit 7 shown in FIG. 7 includes a pull-down or pull-up section 70 and an output control section 72. The operation input unit 7 shown in FIG. 7 is different from that shown in FIG. 3 in that two kinds of pull-down circuits are connected in parallel to each other for an input from the operating unit 6 in the pull-down or pull-up section 70. Specifically, in FIG. 7, drain terminals of two NMOSFETs 75 and 76 are connected to the terminal I1 with resistors R1 and R2, respectively. In addition, the output control section 72 includes a NOR circuit 78. One input terminal of the NOR circuit 78 is connected to a connection point between one end of each of the resistors R1 and R2 and the terminal I1, and the other input terminal is connected to the terminal I2. In addition, the output terminal of the NOR circuit 78 is connected to a terminal OT1 and a gate terminal of the NMOSFET 76.

In addition, source terminals of the NMOSFETs 75 and 76 in FIG. 7 are connected to the power supply VSS similar to the NMOSFET 71 shown in FIG. 3, but the gate terminal connection is different. The gate terminal of the NMOSFET 75 shown in FIG. 7 is connected to an output terminal of an inverting buffer 77, and an input terminal of the inverting buffer 77 is connected to the terminal I2. In addition, the gate terminal of the NMOSFET 76 is connected to an output terminal of the NOR circuit 78.

That is, in the operation input unit 7 shown in FIG. 7, ON/OFF switching of the NMOSFET 75 is controlled by the level obtained by inverting the signal level input to the terminal I2, and control regarding whether to perform pull-down by the resistor R1 is performed. In addition, ON/OFF switching of the NMOSFET 76 is controlled by the output level of the NOR circuit 78 based on the signal level input to the terminal I2 and the signal level input to the terminal I1, and control regarding whether to perform pull-down by the resistor R2 is performed.

For example, the relationship between the resistance of the resistor R1 and the resistance of the resistor R2 is “resistor R1>resistor R2”. In addition, a reset signal is input from the reset circuit 52 of the power control unit 5 to the terminal I2. Accordingly, when the reset signal is controlled to have a Low level, that is, in the case of a normal operation mode where resetting is canceled, the NMOSFET 75 is controlled to be turned on, and ON/OFF switching of the NMOSFET 76 is controlled by the signal level input to the terminal I1. In the second embodiment, a case will be described in which the switch 61 provided in the operating unit 6 is of a push type, that is, both terminals of the switch 61 are electrically connected to each other when the operating unit 6 is pressed and are electrically disconnected from each other when the switch 61 is not pressed. For example, when the push type switch 61 in the operating unit 6 is not pressed and connection between both terminals of the switch 61 is not made accordingly, a Low-level signal is input to the terminal I1. Accordingly, the NMOSFET 76 is turned on. In addition, when the push type switch 61 in the operating unit 6 is pressed so that connection between both terminals of the switch 61 is made, a High-level signal is input to the terminal I1. Accordingly, the NMOSFET 76 is turned off.

That is, in the normal operation mode, when the push type switch 61 is not pressed in the operating unit 6, a signal input from the operating unit 6 is pulled down by the composite resistance of the resistors R1 and R2. In addition, when the switch 61 is pressed in the operating unit 6, the signal input from the operating unit 6 is pulled down only by the resistor R1 with higher resistance than the composite resistance of the resistors R1 and R2. Accordingly, when the switch 61 is pressed in the normal operation mode, electric power consumed in the operation input unit 7 shown in FIG. 7 is reduced by pull-down compared with that when the switch 61 is not pressed.

On the other hand, when the reset signal is controlled to have a High level, that is, in the power saving mode which is reset, both the NMOSFETs 75 and 76 are turned off regardless of the state of the switch 61 of the operating unit 6. That is, by making a control such that a pull-down operation is not performed regardless of the state of the switch 61 in the power saving mode, power consumption by pull-down is suppressed. In this case, since the output of the NOR circuit 78 is controlled to have a Low level regardless of the state of the switch 61, it is prevented that the level of a signal output from the terminal OT1 becomes unfixed due to pull-down.

Although an example of the operation input unit 7 in the second embodiment has been described with reference to FIG. 7, a configuration for ON/OFF control of pull-down using a transistor circuit other than the FET may be adopted instead of the configuration for ON/OFF control of pull-down using MOSFETs in FIG. 7. In addition, the pull-down circuit in the pull-down or pull-up section 70 may be replaced with a pull-up circuit.

FIG. 8 is a table showing an input/output terminal of the operation input unit 7 described using FIG. 7 and the control state of pull-down. As described above, FIG. 8 shows that when the reset signal input to the terminal I2 is controlled to have a High level, a pull-down operation is OFF regardless of the state of the switch 61 and the output of the terminal OT1 is controlled to have a Low level. In addition, FIG. 8 shows that when the reset signal input to the terminal I2 is controlled to have a Low level, pull-down and the output of the terminal OT1 are controlled according to the state of the switch 61.

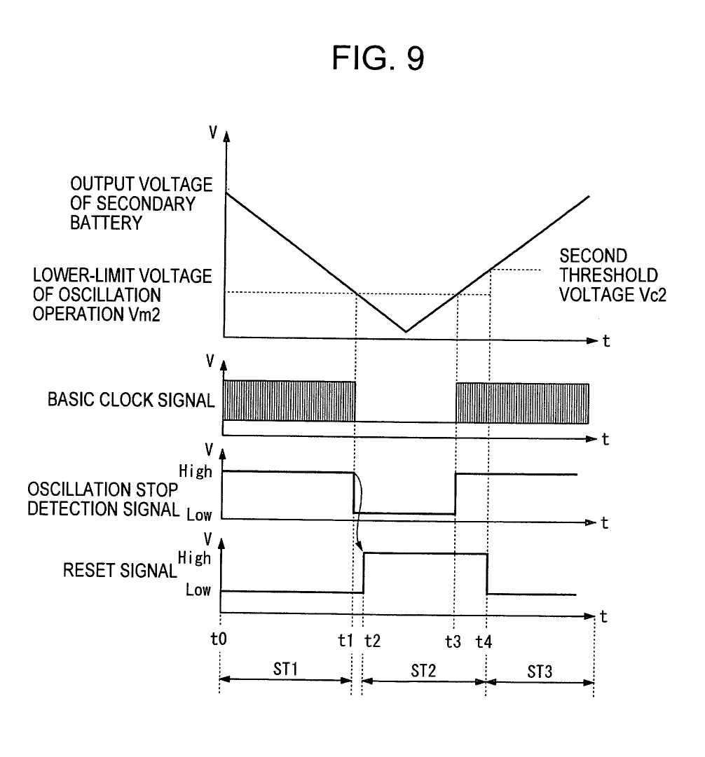

FIG. 9 is a timing chart showing operations of an oscillation stop detection signal and a reset signal in the power control unit 5. Using FIG. 9, an example of the operation of power control of the power control unit 5 will be described.

In a period ST1 of time t0 to time t1, the timepiece device 100 is in a normal operation mode. The oscillation circuit control section 8 oscillates a basic clock signal, and an oscillation stop detection signal is controlled to have a High level. In addition, the reset signal is controlled to have a Low level, such that resetting is canceled. At time t2, the output voltage of the secondary battery 2 drops below a lower-limit oscillation operation voltage Vm2. Accordingly, the output voltage of the constant-voltage oscillation circuit 81 drops, and the oscillation of a basic clock signal in the oscillation circuit control section 8 is stopped. Here, the lower-limit oscillation operation voltage Vm2 is a lower-limit voltage at which a basic clock can oscillate in the oscillation circuit control section 8.

In addition, the oscillation stop detecting circuit 51 of the power control unit 5 detects that oscillation in the oscillation circuit control section 8 has stopped and controls the oscillation stop detection signal to change from a High level to a Low level. Then, the reset circuit 52 controls the reset signal to change from a Low level to a High level when the oscillation stop detection signal changes to a Low level at time t1 (time t2). That is, the power control unit 5 performs transition of the timepiece device 100 from the normal operation mode to the power saving mode at time t1 to t2.

In a period ST2 of time t2 to time t4, the timepiece device 100 is in a power saving mode. At time t3, the output voltage of the secondary battery 2 becomes higher than the lower-limit oscillation operation voltage Vm2. Accordingly, the output voltage of the constant-voltage oscillation circuit 81 is recovered, and the oscillation circuit control section 8 starts the oscillation of a basic clock signal.

At time t4, the output voltage of the secondary battery 2 becomes higher than a second threshold value Vc2 (voltage which is higher by a voltage set in advance than the lower-limit voltage at which a basic clock can oscillate in the oscillation circuit control section 8). Accordingly, the reset circuit 52 controls the reset signal to change from a High level to a Low level to cancel resetting. That is, at time t4, the power control unit 5 performs transition of the timepiece device 100 from the power saving mode to the normal operation mode. In addition, in a period ST3 after time t4, the timepiece device 100 is in a normal operation mode.

Thus, according to the second embodiment, the power control unit 5 controls a reset signal for transition to the power saving mode when the oscillation of a basic clock in the oscillation circuit control section 8 is stopped. Moreover, by controlling the reset signal in the same manner as in the first embodiment, the power control unit 5 stops the operation of the timepiece device 100 and also performs control so as not to pull down or pull up the pull-down or pull-up section 70 connected to an input unit, such as an operation switch. Accordingly, since electric power consumed by pull-down or pull-up in the input unit, such as an operation switch is reduced, the control device 200 can suppress power consumption.

In addition, although an example in which the output control section 72 of the operation input unit 7 includes the NOR circuit 78 is shown in FIG. 3 in the second embodiment, the NOR circuit 78 may be replaced with an OR circuit. For example, when the output control section 72 includes an OR circuit, a signal input from the operating unit 6 through the pull-down or pull-up section 70 may be input to one input terminal of the OR circuit and a reset signal from the power control unit 5 may be input to the other input terminal of the OR circuit. Moreover, in the power saving mode, the power control unit 5 may control a reset signal to have a High level so that the output signal of the OR circuit, that is, a signal output from the operation input unit 7 to the control unit 10 changes to a High level, thereby preventing the signal level from being unfixed. In this case, the power control unit 5 can control ON/OFF switching of the NMOSFET 76 similarly by inputting the output signal of the OR circuit to the gate terminal of the NMOSFET 76 through an inverting buffer. In addition, the output control section 72 of the operation input unit 7 may include an AND circuit, a NAND circuit, or a circuit obtained by combining various kinds of logic circuits as well as the OR circuit and the NOR circuit. In addition, in the power saving mode, the power control unit 5 may input a Low-level or High-level control signal corresponding to each of the various kinds of logic circuits, which are provided in the output control section 72, to change the signal output from the operation input unit 7 to the control unit 10 to the Low level or the High level, thereby preventing the signal level from being unfixed.

Moreover, in the second embodiment, the pull-down or pull-up section 70 of the operation input unit 7 may be configured such that pull-down or pull-up occurs by ON resistance of the MOSFET in the same manner as in the first embodiment. In addition, although an example in which two kinds of pull-down resistors are connected in parallel to each other for an input signal from the operating unit 6 has been described with reference to FIG. 7, the invention is not limited to this form. For example, one kind of pull-down circuit or pull-up circuit may be used in the same manner as in the first embodiment, or two or more kinds of pull-down circuits or pull-up circuits may be used.

In addition, although the digital display type timepiece has been described as an example of the timepiece device 100 according to the second embodiment, an analog display type timepiece may also be used. In addition, although the timepiece device 100 according to the present embodiment has been described, an electronic apparatus which executes a predetermined operation (operation set in advance) with a power supply voltage supplied from the solar cell 1 and the secondary battery 2 may be used instead of the timepiece device 100.

### Third Embodiment

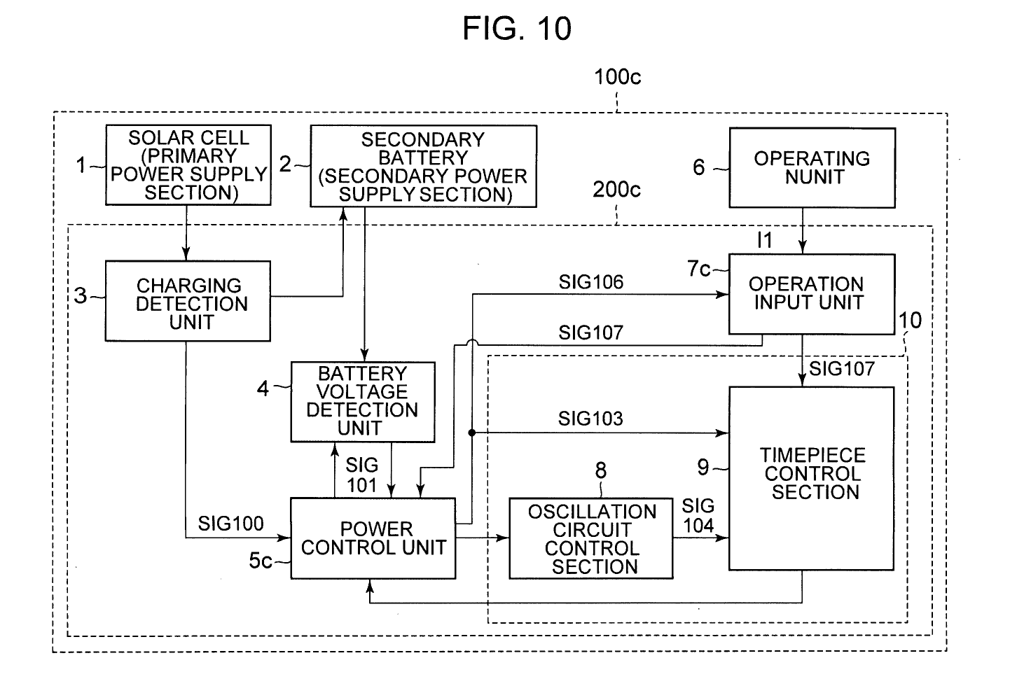

Subsequently, a timepiece device 100c including a control device 200c according to a third embodiment of the invention will be described. FIG. 10 is a block diagram showing the schematic configuration of the timepiece device 100c according to the third embodiment of the invention. If the timepiece device 100c (FIG. 10) according to the third embodiment is compared with the timepiece device 100 (FIG. 1) according to the first embodiment, the power control unit 5 (FIG. 1) is changed to a power control unit 5c (FIG. 10), and the operation input unit 7 is changed to an operation input unit 7c.

In addition, sections in FIG. 10 corresponding to the sections in FIG. 1 are denoted by the same reference numerals, and the explanation will be appropriately omitted.

First, the outline of the third embodiment will be described. In the third embodiment, when a charging state of the secondary battery 2 is detected in a power saving mode, the power control unit 5c of the timepiece device 100c determines the state of the operating unit 6 by inserting a pull-down resistor between a terminal I1 and a power supply VSS. The power control unit 5c allows the return from the power saving mode to the normal operation mode when the switch 61 of the operating unit 6 is in an electrically conductive state (for example, OFF (pressed) state if the operating unit 6 is a crown switch and ON (input) state if the operating unit 6 is a side switch) and does not allow the return from the power saving mode to the normal operation mode in other cases.

In this case, since the power control unit 5c does not allow unnecessary return from the power saving mode to the normal operation mode, it is possible to suppress power consumption of the secondary battery 2 caused by the return.

Next, the operation input unit 7c will be described. Since the circuit configuration of the operation input unit 7c is the same as that of the operation input unit 7 in the first embodiment shown in FIG. 3, the explanation will be omitted. However, the circuit configuration of the operation input unit 7c is different from that of the operation input unit 7 in the first embodiment shown in FIG. 3 in that the terminal OT1 of the operation input unit 7c is connected to the power control unit 5c and the timepiece control section 9.

In addition, the operation input unit 7c has the same function as the operation input unit 7 in the first embodiment, but the following things are different. The operation input unit 7c generates a switch state signal SIG107 on the basis of a signal from an operation switch input from the operating unit 6 and a pull-down instruction signal SIG106 input from the power control unit 5c. In addition, the operation input unit 7c outputs the generated switch state signal SIG107 to the power control unit 5c and the timepiece control section 9.

Specifically, for example, when the switch 61 of the operating unit 6 is in a cut-off state (open state), the operation input unit 7c changes the switch state signal SIG107 to a Low level state (hereinafter, referred to as an L state) regardless of the input pull-down instruction signal SIG106. Thus, when the switch 61 is in an open state, the operation input unit 7c changes the switch state signal SIG107 to the L state so that return from the power saving mode to the normal operation mode is not allowed.

On the other hand, when the input pull-down instruction signal SIG106 is in a High level state (hereinafter, referred to as an H state) when the switch 61 of the operating unit 6 is in an electrically conductive state, the operation input unit 7c changes the switch state signal SIG107 to the H state. Here, the H-state pull-down instruction signal SIG106 is a signal indicating transition to the normal operation mode. Thus, when the pull-down instruction signal SIG106 is in the H state and the switch 61 is in the electrically conductive state, the operation input unit 7c changes the switch state signal SIG107 to the H state so that the return from the power saving mode to the normal operation mode by the power control unit 5c is allowed.

On the other hand, when the input pull-down instruction signal SIG106 is in the L state when the switch 61 of the operating unit 6 is in an electrically conductive state, the operation input unit 7c changes the switch state signal SIG107 to the L state. Here, the L-state pull-down instruction signal SIG106 is a signal indicating transition to the power saving mode. Thus, when the pull-down instruction signal SIG106 is in the L state even if the switch 61 of the operating unit 6 is in an electrically conductive state, the operation input unit 7c does not allow the return from the power saving mode to the normal operation mode.

As described above, only when the pull-down instruction signal SIG106 is in the H state and the switch 61 is in the electrically conductive state, the operation input unit 7c changes the switch state signal SIG107 to the H state so that the return from the power saving mode to the normal operation mode by the power control unit 5c is allowed.

As a result, since the operation input unit 7c prevents unnecessary return from the power saving mode to the normal operation mode by the power control unit 5c, it is possible to suppress power consumption of the secondary battery caused by the return to the normal operation mode.

Next, the outline of processing of the power control unit 5c will be described. The power control unit 5c generates a mode instruction signal SIG103, which instructs a normal operation mode or a power saving mode, on the basis of the switch state signal SIG107 input from the operation input unit 7c, a charging state detection signal SIG100 input from the charging detection unit 3, and a voltage detection signal SIG101 input from the battery voltage detection unit 4. In addition, the power control unit 5c outputs the generated mode instruction signal SIG103 to the timepiece control section 9.

In addition, when the H-state charging state detection signal SIG100 indicating a charging state of the secondary battery 2 is received from the charging detection unit 3 in the power saving mode, the power control unit 5c outputs an H-state pull-down signal to the operation input unit 7c. Accordingly, the operation input unit 7c can determine the state of the operating unit 6 by inserting a pull-down resistor of an NMOSFET between the terminal I1 and the power supply VSS (pull-down resistor ON).

Moreover, in the normal operation mode, when the L-state voltage detection signal SIG101 indicating that the voltage of the secondary battery 2 is equal to or lower than a threshold value set in advance is received from the battery voltage detection unit 4 and the L-state charge detection signal SIG100 indicating the uncharged state of the secondary battery 2 is received from the charging detection unit 3, the power control unit 5c outputs an L-state pull-down signal to the operation input unit 7c. In this way, the operation input unit 7c removes the pull-down resistor of the NMOSFET between the terminal I1 and the power sources VSS (pull-down resistor OFF).

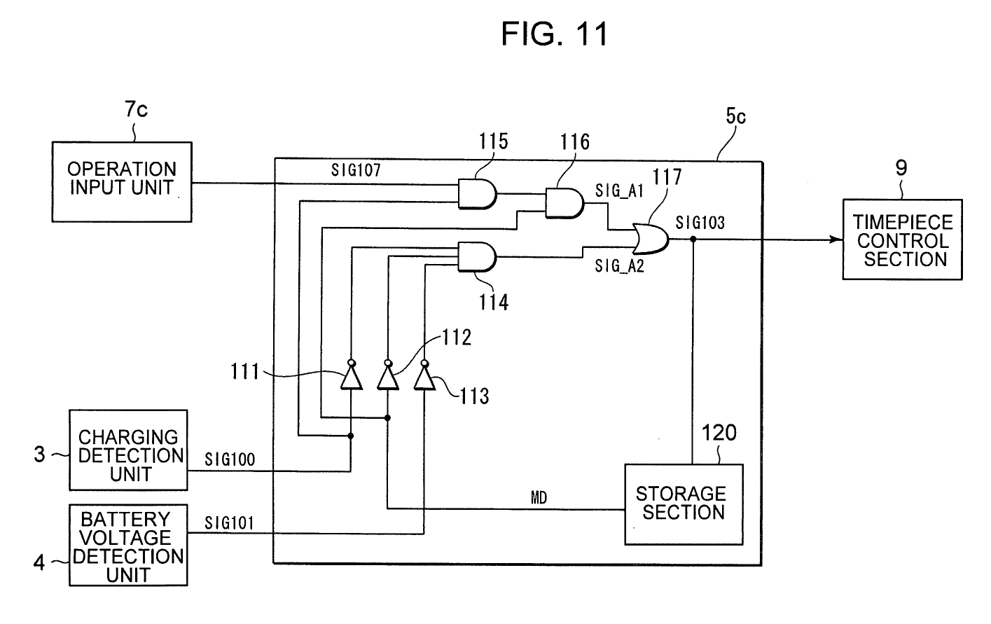

Hereinafter, an example of the configuration of the power control unit 5c will be described with reference to FIG. 11. FIG. 11 is a block diagram showing an example of the schematic configuration of the power control unit 5c in the third embodiment. The power control unit 5c includes an inverter 111, an inverter 112, an inverter 113, an AND circuit 114, a NAND circuit 115, an AND circuit 116, an OR circuit 117, and a storage section 120.

An input terminal of the inverter 111 is connected to the charging detection unit 3 and one input terminal of the NAND circuit 115, and an output terminal of the inverter 111 is connected to an input terminal, to which an output terminal of the inverter 112 and an output terminal of the inverter 113 are not connected, among three input terminals of the AND circuit 114.

An input terminal of the inverter 112 is connected to the storage section 120 and one input terminal of the AND circuit 116, and an output terminal of the inverter 112 is connected to an input terminal, to which the output terminal of the inverter 111 and the output terminal of the inverter 113 are not connected, among the three input terminals of the AND circuit 114.

An input terminal of the inverter 113 is connected to the battery voltage detection unit 4, and an output terminal of the inverter 113 is connected to an input terminal, to which the output terminal of the inverter 111 and the output terminal of the inverter 112 are not connected, among the three input terminals of the AND circuit 114.

The AND circuit 114 has three input terminals, which are connected to the output terminals of the inverters 111 to 113, and an output terminal connected to one input terminal of the OR circuit 117.

One input terminal of the NAND circuit 115 is connected to the operation input unit 7c and the other input terminal is connected to a line, which connects the charging detection unit 3 and the input terminal of the inverter 111 to each other, and the output terminal of the NAND circuit 115 is connected to one input terminal of the AND circuit 116.

One input terminal of the AND circuit 116 is connected to the output terminal of the NAND circuit 115 and the other input terminal is connected to a line, which connects the storage section 120 and the input terminal of the inverter 112 to each other, and the output terminal of the AND circuit 116 is connected to one input terminal of the OR circuit 117.

One input terminal of the OR circuit 117 is connected to the output terminal of the AND circuit 116 and the other input terminal is connected to the output terminal of the AND circuit 114, and the output terminal of the OR circuit 117 is connected to the timepiece control section 9 and the storage section 120.

The storage section 120 is connected to the output terminal of the OR circuit 117, the input terminal of the inverter 112, and one input terminal of the AND circuit 116.

Here, the charging state detection signal SIG100 indicates a charging state where charging from the solar cell 1 to the secondary battery 2 is performed in the H state and an uncharged state where charging from the solar cell 1 to the secondary battery 2 is not performed in the L state. In addition, the voltage detection signal SIG101 indicates that the secondary battery 2 is higher than a comparison voltage set in advance in the H state and the secondary battery 2 is equal to or lower than the comparison voltage set in advance in the L state. In addition, the mode instruction signal SIG103 indicates that a power saving mode is instructed in the H state and a normal operation mode is instructed in the L state.

Next, the outline of processing of the power control unit 5c in FIG. 11 will be described. The power control unit 5c forms a selection circuit which selects an output signal SIG_A1 of the AND circuit 116 and an output signal SIG_A2 of the AND circuit 114. That is, the power control unit 5c selects one of the two output signals SIG_A1 and SIG_A2, as the mode instruction signal SIG103, on the basis of a current mode signal MD indicating a current mode read from the storage section 120, and outputs the selected mode instruction signal SIG103 to the timepiece control section 9.

The current mode signal MD indicating the current mode is stored in advance in the storage section 120, and the storage section 120 outputs the stored current mode signal MD to the inverter 112 and the AND circuit 116 in synchronization with a clock signal (not shown).

Next, details of the processing of the power control unit 5c in FIG. 11 in the power saving mode and the normal operation mode will be described.

First, in the power saving mode, the inverter 112 receives the current mode signal MD, which is in the H state, from the storage section 120. Here, the H-state current mode signal MD indicates the power saving mode. The inverter 112 generates an L-state signal by inverting the received H-state current mode signal MD and outputs the generated L-state signal to the AND circuit 114.

To the AND circuit 114, the L-state signal is input from the inverter 112. Accordingly, the AND circuit 114 generates the L-state output signal SIG_A2 regardless of other input signals and outputs the generated L-state output signal SIG_A2 to the OR circuit 117.

To the OR circuit 117, the L-state output signal SIG_A2 is input from the AND circuit 114. Accordingly, the OR circuit 117 sets the state of the output signal SIG_A1, which is the other input, as the state of the mode instruction signal SIG103 and outputs the mode instruction signal SIG103 to the timepiece control section 9. Accordingly, when the current mode signal MD is in the H state, the power control unit 5c selects the output signal SIG_A1 as the mode instruction signal SIG103 which is output to the timepiece control section 9. Here, the H-state current mode signal MD indicates that the current mode is a power saving mode.

The NAND circuit 115 generates an output signal on the basis of the switch state signal SIG107 input from the operation input unit 7c and the charging state detection signal SIG100 input from the charging detection unit 3.

Specifically, when the switch state signal SIG107 is in the H state, the NAND circuit 115 generates an L-state output signal and outputs the generated L-state output signal to the AND circuit 116. Here, the H-state switch state signal SIG107 indicates that the switch 61 is in the electrically conductive state and the pull-down instruction signal is in the H state.

In this case, since the output signal input from the NAND circuit 115 is in the L state, the AND circuit 116 generates the L-state output signal SIG_A1 and outputs the generated L-state output signal SIG_A1 to the OR circuit 117.

As a result, since both the output signals SIG_A1 and SIG_A2 input to the OR circuit 117 are in the L state, the OR circuit 117 generates the L-state mode instruction signal SIG103 and outputs the generated L-state mode instruction signal SIG103 to the timepiece control section 9. Thus, the power control unit 5c can give an instruction for transition to the normal operation mode to the timepiece control section 9.

In addition, the current mode signal MD is changed to the L state indicating the normal operation mode by updating the current mode signal MD stored in the storage section 120 with the L-state mode instruction signal SIG103.

On the other hand, when the switch state signal SIG107 is in the L state (when the switch 61 is in an open state or in the case of the L-state pull-down instruction signal SIG106) or when the charging state detection signal SIG100 is in the L state (in the case of uncharged state), the NAND circuit 115 generates an H-state output signal and outputs the generated H-state output signal to the AND circuit 116.

In this case, since the output signal input from the NAND circuit 115 is in the H state and the current mode signal MD input from the storage section 120 is in the H state in the power saving mode, the AND circuit 116 generates the H-state output signal SIG_A1 and outputs the generated H-state output signal SIG_A1 to the OR circuit 117.

As a result, since the output signal SIG_A1 input to the OR circuit 117 is in the H state, the OR circuit 117 generates the H-state mode instruction signal SIG103 and outputs the generated H-state mode instruction signal SIG103 to the timepiece control section 9. In this manner, the power control unit 5c can give an instruction for transition to the power saving mode to the timepiece control section 9, but mode transition does not occur because the current mode is a power saving mode. Accordingly, the timepiece control section 9 maintains the power saving mode.

Subsequently, processing of the power control unit 5c when the current mode is a normal operation mode will be described. The AND circuit 116 reads the current mode signal MD from the storage section 120. Since the current mode is a normal operation mode, the current mode signal MD is in the L state. Accordingly, the AND circuit 116 generates the L-state output signal SIG_A1 regardless of a signal input to the other input terminal and outputs the generated L-state output signal SIG_A1 to the OR circuit 117.

Since the L-state output signal SIG_A1 is input from the AND circuit 116 to the OR circuit 117, the OR circuit 117 sets the state of the output signal SIG_A2, which is the other input, as the state of the mode instruction signal SIG103 and outputs the mode instruction signal SIG103 to the timepiece control section 9. Accordingly, when the current mode signal MD is in the L state, the power control unit 5c selects the output signal SIG_A2 as the mode instruction signal SIG103 which is output to the timepiece control section 9. Here, the L-state current mode signal MD indicates that the current mode is a normal operation mode.

Since the current mode is a normal operation mode, the inverter 112 receives the L-state current mode signal MD from the storage section 120. Here, the L-state current mode signal MD indicates that the current mode is a normal operation mode. The inverter 112 generates an H-state signal by inverting the input L-state current mode signal MD and outputs the generated H-state signal to the AND circuit 114.

Since the signal input from the inverter 112 is in the H state, the output of the AND circuit 114 depends on the output signal of the inverter 111, which is another input, and the output signal of the inverter 113.

Here, the inverter 111 inverts the charging state detection signal SIG100 input from the charging detection unit 3 and outputs the inversion signal of the charging state detection signal SIG100, which is obtained by inversion, to the AND circuit 114. In addition, the inverter 112 inverts the voltage detection signal SIG101 input from the battery voltage detection unit 4 and outputs the inversion signal of the voltage detection signal SIG101, which is obtained by inversion, to the AND circuit 114.

Accordingly, only when the charging state detection signal SIG100 is in the L state and the voltage detection signal SIG101 is in the L state, the AND circuit 114 generates the H-state output signal SIG_A2. That is, only when the current state is an uncharged state and the voltage of the secondary battery 2 is equal to or lower than the threshold value set in advance, the AND circuit 114 generates the H-state output signal SIG_A2.

Then, the AND circuit 114 outputs the generated H-state output signal SIG_A2 to the OR circuit 117.

As a result, since the output signal SIG_A2 input from the AND circuit 114 is in the H state, the OR circuit 117 generates the H-state mode instruction signal SIG103 indicating the power saving mode and outputs the generated H-state mode instruction signal SIG103 to the timepiece control section 9.

Thus, in the normal operation mode, the power control unit 5c can give to the timepiece control section 9 an instruction for transition from the normal operation mode to the power saving mode when the current state is an uncharged state and the voltage of the secondary battery 2 is equal to or lower than the threshold value set in advance.

In addition, the OR circuit 117 updates the current mode signal stored in the storage section 120 with the generated H-state mode instruction signal SIG103. Accordingly, the OR circuit 117 can change the current mode signal to have an H state indicating the power saving mode.

On the other hand, when the charging state detection signal SIG100 is in the H state (in the charging state) or when the voltage detection signal SIG101 is in the H state (when the voltage of the secondary battery 2 exceeds the threshold value set in advance), the AND circuit 114 generates the L-state output signal SIG_A2. Then, the AND circuit 114 outputs the generated L-state output signal SIG_A2 to the OR circuit 117.

As a result, since the output signal SIG_A2 input from the AND circuit 114 is in the L state, the OR circuit 117 generates the L-state mode instruction signal SIG103 indicating the normal operation mode and outputs the generated L-state mode instruction signal SIG103 to the timepiece control section 9.

In this manner, the power control unit 5c can give an instruction for transition to the normal operation mode to the timepiece control section 9, but mode transition does not occur because the current mode is a normal operation mode. Accordingly, the timepiece control section 9 maintains the normal operation mode.

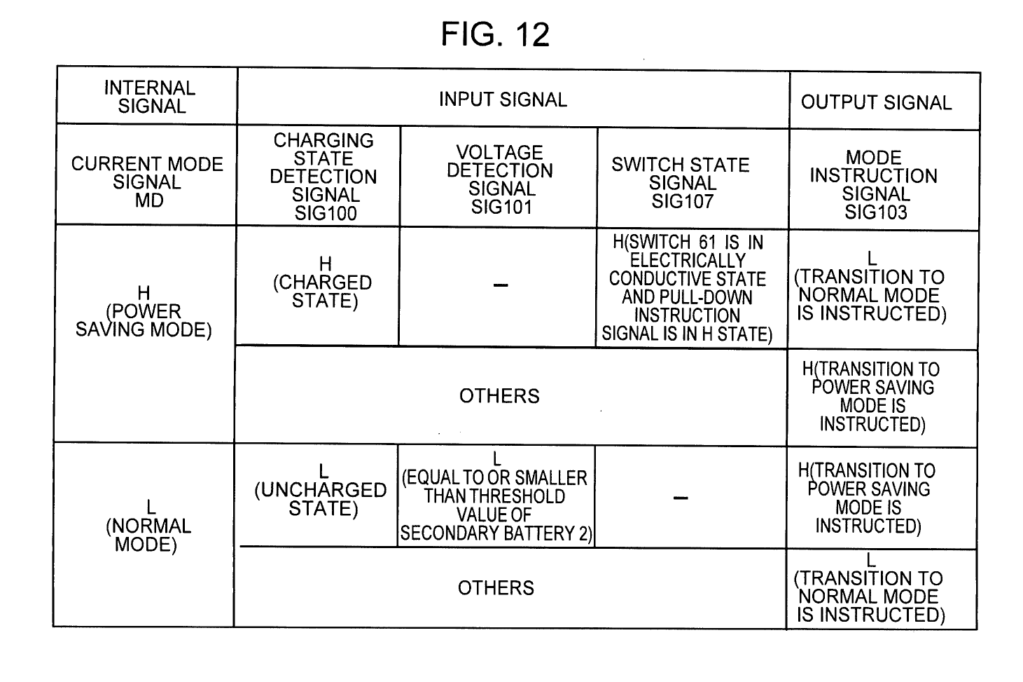

FIG. 12 is a table in which the relationship of the current mode signal MD which is an internal signal of the power control unit 5c, an input signal, and an output signal is summarized. In FIG. 12, the relationship of the current mode signal MD, the charging state detection signal SIG100, the voltage detection signal SIG101, the switch state signal SIG107, and the mode instruction signal SIG103 are shown.

Referring to FIG. 12, when the current mode signal MD is in the H state, the mode instruction signal SIG103 is in the L state only when the charging state detection signal SIG100 is in the H state and the switch state signal SIG107 is in the H state regardless of the voltage detection signal SIG101.

That is, when the current mode is a power saving mode, the power control unit 5c gives an instruction for transition to the normal operation mode to the timepiece control section 9 only when the state is a charging state, the switch 61 is in the electrically conductive state, and the pull-down instruction signal is in the H state.

In addition, referring to FIG. 12, when the current mode signal MD is in the H state, the mode instruction signal SIG103 is in the H state when a combination of the charging state detection signal SIG100, the voltage detection signal SIG101, and the switch state signal SIG107 is not the above case.

That is, when the current mode is a power saving mode, the power control unit 5c gives an instruction for transition to the power saving mode to the timepiece control section 9 except for when the state is a charging state, the switch 61 is in the electrically conductive state, and the pull-down instruction signal is in the H state. In this case, since the state is already a power saving mode, the timepiece control section 9 maintains the power saving mode.

In addition, referring to FIG. 12, when the current mode signal MD is in the L state, the mode instruction signal SIG103 is in the H state only when the charging state detection signal SIG100 is in the L state and the voltage detection signal SIG101 is in the L state regardless of the switch state signal SIG107.

That is, when the current mode is a normal operation mode, the power control unit 5c gives an instruction for transition to the power saving mode to the timepiece control section 9 only when the state is an uncharged state and the voltage of the secondary battery 2 is equal to or lower than a threshold value set in advance (the voltage of the secondary battery 2 drops).

In addition, referring to FIG. 12, when the current mode signal MD is in the L state, the mode instruction signal SIG103 is in the L state when a combination of the charging state detection signal SIG100, the voltage detection signal SIG101, and the switch state signal SIG107 is not the above case.

That is, when the current mode is a normal operation mode, the power control unit 5c gives an instruction for transition to the normal operation mode to the timepiece control section 9 except for when the state is an uncharged state and the voltage of the secondary battery 2 is equal to or lower than the threshold value set in advance (the voltage of the secondary battery 2 drops). In this case, since the state is already a normal operation mode, the timepiece control section 9 maintains the normal operation mode.

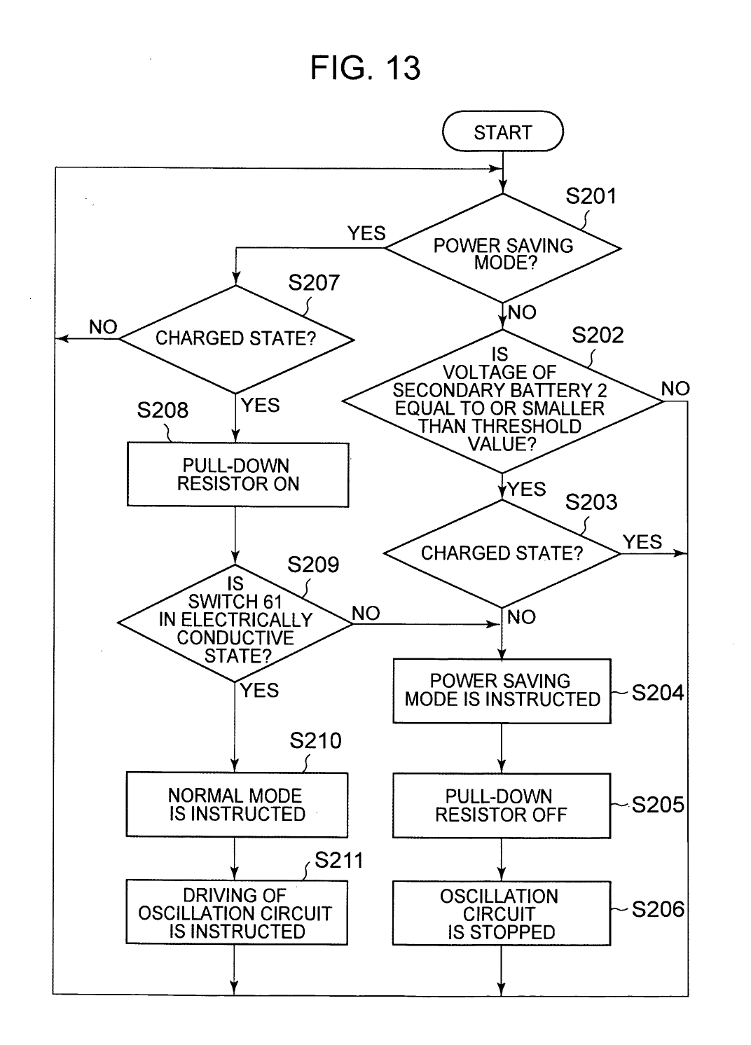

FIG. 13 is a flow chart showing the flow of processing of the timepiece device 100c according to the third embodiment. First, the power control unit 5c determines whether or not the current mode is a power saving mode (step S201). When the current mode is a normal operation mode (NO in step S201), the power control unit 5c determines whether or not the voltage of the secondary battery 2 is equal to or lower than the threshold value set in advance (step S202).

When the voltage of the secondary battery 2 is not equal to or lower than the threshold value set in advance (No in step S202), the power control unit 5c returns to the processing in step S201. On the other hand, when the voltage of the secondary battery 2 is equal to or lower than the threshold value set in advance (YES in step S202), the power control unit 5c determines whether or not the secondary battery 2 is in a charging state (step S203). When the secondary battery 2 is in the charging state (YES in step S203), the power control unit 5c returns to the processing in step S201.

On the other hand, when the secondary battery 2 is not in the charging state (NO in step S203), the power control unit 5c gives an instruction for transition to the power saving mode to the timepiece control section 9 (step S204). Then, the power control unit 5c outputs an L-state pull-down signal to the operation input unit 7c to turn off the pull-down resistor (step S205). Then, the power control unit 5c controls the oscillation circuit control section 8 to stop the oscillation circuit (step S206).

Then, the process returns to step S201. When the current mode is a power saving mode (YES in step S201), the power control unit 5c determines whether or not the secondary battery 2 is in a charging state (step S207). When the secondary battery 2 is not in the charging state (NO in step S207), the power control unit 5c returns to the processing in step S201.

On the other hand, when the secondary battery 2 is in a charging state (YES in step S207), the power control unit 5c outputs an H-state pull-down signal to the operation input unit 7c to turn on the pull-down resistor (step S208). Then, the power control unit 5c determines whether or not the switch 61 is in an electrically conductive state (step S209).

When the switch 61 is not in the electrically conductive state (NO in step S209), the power control unit 5c returns to the processing in step S204. On the other hand, when the switch 61 is in the electrically conductive state (YES in step S209), the power control unit 5c gives an instruction for transition to the normal operation mode to the timepiece control section (step S210). Then, the power control unit 5c gives an instruction for driving of the oscillation circuit to the oscillation circuit control section 8 (step S211). In this way, the processing based on this flow chart ends.

As described above, when a charging state of the secondary battery 2 is detected in a power saving mode, the power control unit 5c of the timepiece device 100c determines a state of the operating unit 6 by inserting a pull-down resistor between the terminal I1 and the power supply VSS. The power control unit 5c allows the return from the power saving mode to the normal operation mode when the switch 61 of the operating unit 6 is in an electrically conductive state (for example, OFF (pressed) state if the operating unit 6 is a crown switch and ON (input) state if the operating unit 6 is a side switch) and does not allow the return from the power saving mode to the normal operation mode in other cases.

Thus, since the power control unit 5c allows the return from the power saving mode to the normal operation mode only when the state of the switch 61 of the operating unit 6 is in the electrically conductive state, it is possible to eliminate unnecessary return from the power saving mode to the normal operation mode. As a result, the power control unit 5c can suppress power consumption of the secondary battery 2.

In addition, similar to the first embodiment, the timepiece device 100c according to the present embodiment stops the operation of the timepiece device 100c and performs control so as not to pull down or pull up the pull-down or pull-up section 70, which is connected to the operation input unit 7c, in the power saving mode. Therefore, since electric power consumed by pull-down or pull-up in the operation input unit 7c is reduced, it is possible to suppress power consumption.

Moreover, in the present embodiment, the output control section 72 of the operation input unit 7c includes the AND circuit 74 as in the first embodiment. However, the output control section 72 of the operation input unit 7c may include a NAND circuit instead of the AND circuit 74. For example, when the output control section 72 includes a NAND circuit, a signal input from the operating unit 6 through the pull-down or pull-up section 70 may be input to one input terminal of the NAND circuit and a pull-down signal input from the power control unit 5c may be input to the other input terminal of the NAND circuit. Moreover, in the power saving mode, the power control unit 5 may control a control signal to have a Low level so that an output signal of the NAND circuit, which is a signal output from the operation input unit 7c to the control unit 10, changes to a High level, thereby preventing the signal level from being unfixed.

In addition, the output control section 72 of the operation input unit 7c may include an OR circuit, a NOR circuit, or a circuit obtained by combining various kinds of logic circuits as well as the AND circuit and the NAND circuit. In addition, in the power saving mode, the power control unit 5c may input a Low-level or High-level control signal corresponding to each of the various kinds of logic circuits, which are provided in the output control section 72, to change the signal output from the operation input unit 7 to the control unit 10 to the Low level or the High level, thereby preventing the signal level from being unfixed.

In addition, similar to the first embodiment, an example in which the pull-down or pull-up section 70 of the operation input unit 7c includes a pull-down or pull-up MOSFET is shown in the present embodiment. However, the invention is not limited to this. For example, the pull-down or pull-up section 70 of the operation input unit 7c may include a pull-down or pull-up resistor and a transistor circuit which is connected in series to the resistor and performs switching so as to be electrically connected to or disconnected from the resistor. In this case, the power control unit 5 may control pull-down or pull-up according to control of ON switching (conduction) and OFF switching (cut-off) of the transistor circuit.

In addition, although the analog display type timepiece has been described as an example of the timepiece device 100c according to the present embodiment, a digital display type timepiece may also be used. In addition, although the timepiece device 100c according to the first embodiment has been described, an electronic apparatus which executes a predetermined operation (operation set in advance) with a power supply voltage supplied from the solar cell 1 and the secondary battery 2 may be used instead of the timepiece device 100.

As described in the first to third embodiments, the power control unit 5 or 5c of the control device 200 or 200c controls the control unit 10 so as not to execute a predetermined operation (operation set in advance) and also controls the operation input unit 7 or 7c so as not to execute a pull-down or pull-up operation according to the state of electric power supplied from the secondary battery 2. Therefore, the control device 200 can suppress power consumption in the timepiece device 100 according to the state of electric power supplied from the secondary battery 2.

In addition, when the secondary battery 2 is in an uncharged state, in which the secondary battery 2 is not being charged by the solar cell 1, as the state of electric power supplied from the secondary battery 2, the power control unit 5 or 5c controls the control unit 10 so as not to execute a predetermined operation (operation set in advance) and also performs transition of the operation input unit 7 or 7c to the power saving mode in which no control for pull-down or pull-up is performed. Accordingly, for example, when the timepiece device 100 or 100c is in the dark where the solar cell 1 is not irradiated with light and accordingly, an electromotive force cannot be generated and the secondary battery 2 cannot be charged, the power control unit 5 stops the operation of the timepiece device 100 or 100c and also performs control such that pull-down or pull-up does not occur in the operation input unit 7 or 7c. Therefore, when the secondary battery 2 is in the uncharged state, the control device 200 can suppress power consumption in the timepiece device 100 or 100c.

On the other hand, when the secondary battery 2 is not in the uncharged state, the power control unit 5 or 5c controls the control unit 10 to execute a predetermined operation (operation set in advance) and performs transition of the operation input unit 7 to the normal operation mode in which control for pull-down or pull-up is performed. Accordingly, when the solar cell 1 generates an electromotive force to electrically charge the secondary battery 2, the power control unit 5 or 5c controls the timepiece device 100 or 100c to execute a predetermined operation (operation set in advance) and performs control for pull-down or pull-up in the operation input unit 7. Therefore, when the secondary battery 2 is not in the uncharged state, the control device 200 can make the timepiece device 100 or 100c normally operate.

In addition, when the secondary battery 2 is in the uncharged state and the output voltage (potential difference) of the secondary battery 2 is equal to or lower than a threshold value set in advance, the power control unit 5 or 5c performs transition of the timepiece device 100 or 100c to the power saving mode. Accordingly, when the solar cell 1 cannot generate an electromotive force and the output voltage of the secondary battery 2 drops, the power control unit 5 or 5c performs transition of the timepiece device 100 or 100c to the power saving mode. As a result, the control device 200 can suppress power consumption in the timepiece device 100 or 100c when the secondary battery 2 is in the uncharged state and the output voltage drops.

In addition, when the secondary battery 2 is in the uncharged state and the uncharged state continues for a predetermined time or more, the power control unit 5 or 5c performs transition of the timepiece device 100 or 100c to the power saving mode. Then, when a state where the solar cell 1 cannot generate an electromotive force continues, for example, when a dark state where the solar cell 1 is not irradiated with light in the timepiece device 100 or 100c continues for a predetermined time or more, the power control unit 5 or 5c performs transition of the timepiece device 100 or 100c to the power saving mode. As a result, the control device 200 can suppress power consumption in the timepiece device 100 or 100c when the secondary battery 2 is in the uncharged state and the uncharged state continues for a predetermined time or more.

In addition, when a signal according to the operation set in advance is input from the operating unit 6, the secondary battery 2 is in the uncharged state, and this uncharged state continues for a period set in advance or more, the power control unit 5 or 5c performs transition of the timepiece device 100 or 100c to the power saving mode. Accordingly, for example, until the timepiece device 100 or 100c is delivered to a store or a purchaser after shipping from a factory or when a dark state continues from the time the timepiece device 100 or 100c is put in the box in a state where a crown switch is pulled out, the power control unit 5 or 5c performs transition of the timepiece device 100 or 100c to the power saving mode. Therefore, when the signal according to the operation set in advance is input from the operating unit 6, the secondary battery 2 is in the uncharged state, and this uncharged state continues for a period set in advance or more, the control device 200 can suppress power consumption in the timepiece device 100 or 100c.

In addition, the control device 200 includes the oscillation circuit control section 8 which generates a basic clock used for operation of the control unit 10 by oscillation when electric power is supplied. When the oscillation circuit control section 8 stops the oscillation of the basic clock which oscillates when electric power is supplied, the power control unit 5 or 5c controls the control unit 10 so as not to execute a predetermined operation (operation set in advance) and also performs transition of the operation input unit 7 to the power saving mode in which no control for pull-down or pull-up is performed. Accordingly, for example, when the oscillation of a basic clock in the oscillation circuit control section 8 stops since the output voltage (potential difference) supplied from the secondary battery 2 becomes equal to or lower than the lower-limit voltage (potential difference) at which a basic clock can oscillate in the oscillation circuit control section 8, the power control unit 5 or 5c stops the operation of the timepiece device 100 or 100c and also performs control such that pull-down or pull-up does not occur in the operation input unit 7. Accordingly, when the oscillation of a basic clock in the oscillation circuit control section 8 stops, the control device 200 can suppress power consumption in the timepiece device 100 or 100c.

Moreover, in the power saving mode, it is determined whether or not the output voltage (potential difference) supplied from the secondary battery 2 is equal to or higher than a voltage (potential difference) which is higher by a voltage (potential difference) set in advance than the lower-limit voltage (potential difference) at which a basic clock can oscillate in the oscillation circuit control section 8. When the output voltage (potential difference) is equal to or higher than the voltage (potential difference) which is higher by the voltage (potential difference) set in advance than the lower-limit voltage (potential difference) at which a basic clock can oscillate in the oscillation circuit control section 8, the power control unit 5 or 5c controls the control unit 10 to execute a predetermined operation (operation set in advance) and also performs control for pull-down or pull-up in the operation input unit 7. Accordingly, when the output voltage (potential difference) supplied from the secondary battery 2 is higher by a predetermined voltage (potential difference) than the lower-limit voltage (potential difference) at which a basic clock can oscillate in the oscillation circuit control section 8, the control device 200 can make the timepiece device 100 or 100c normally operate.

Moreover, as described with reference to FIGS. 3 and 7, a special circuit is not needed as a circuit which performs control for pull-down or pull-up in the operation input unit 7. Accordingly, increases in cost and the component area can be suppressed compared with that in the case where a special circuit is used.

In addition, although an example where the solar cell 1 is used as a primary power supply unit has been described in each embodiment, a primary power supply unit having a different power generation function may be used instead of the solar cell 1. In addition, although an example where the secondary battery 2 is used as a secondary power supply unit has been described, a capacitor may be used instead of the secondary battery 2.

In addition, although the timepiece device 100 or 100c including the solar cell 1 and the secondary battery 2 therein has been described in each embodiment, the solar cell 1 and the secondary battery 2 may be provided outside the timepiece device 100 or 100c, and electric power may be supplied to the timepiece device 100 or 100c from the solar cell 1 and the secondary battery 2 provided outside.

Moreover, each embodiment may also be applied to the control device 200, the timepiece device 100 or 100c, or an electronic apparatus which performs transition to a power saving mode according to electric power supplied from a primary battery instead of electric power supplied from the solar cell 1 and the secondary battery 2.

In addition, although the timepiece device 100 or 100c has been described as an example in each embodiment, an electronic apparatus which executes a predetermined operation (operation set in advance) may be used without being limited to the timepiece device 100 or 100c. Instead of the timepiece device 100 or 100c, electronic apparatuses, such as an electronic calculator, an electronic dictionary, a mobile phone, a handheld videogames machine, and a portable computer, may be used or an electronic remote control for operating an electronic apparatus by remote control may be used, for example.

In addition, the charging detection unit 3, the battery voltage detection unit 4, the power control unit 5 or 5c, the operation input unit 7 or 7c, the oscillation circuit control section 8, and the timepiece control section 9 in the control device 200 or 200c shown in FIG. 1 or 10 or the power control unit 5, the operation input unit 7, the oscillation circuit control section 8, and the timepiece control section 9 in the control device 200 shown in FIG. 6 may be realized by hardware for dedicated use. Alternatively, they may be formed by a memory and a CPU (central processing unit), and a function of each unit may be realized by loading a program for realizing the function of each unit of the control device 200 shown in FIG. 1 or 6 to the memory and executing it.

In addition, the processing of each section described above may be performed by recording a program for realizing the function of each section in the control device 200 or 200c shown in FIG. 1, 6, or 10 in a computer-readable recording medium, reading the program recorded in the recording medium into a computer system, and executing the read program. In addition, the ‘computer system’ referred herein may include an OS or hardware, such as peripheral devices.

In addition, the ‘computer system’ may include a homepage presenting environment (or display environment) if a WWW system is used.

In addition, examples of the ‘computer-readable recording medium’ include portable media, such as a flexible disc, a magneto-optic disc, a ROM, and a CD-ROM, and a storage device, such as a hard disk built in a computer system. In addition, examples of the ‘computer-readable recording medium’ may include a recording medium that stores a program dynamically for a short period of time like a network, such as the Internet, or a communication line when a program is transmitted through a communication line, such as a telephone line, and include a recording medium that stores a program for a predetermined period of time like a volatile memory in a computer system which serves as a server or a client. In addition, the above program may be a program for realizing some of the functions described above or may be a program capable of realizing the above functions by combination with a program already recorded in the computer system.

While the embodiments of the invention have been described in detail with reference to the accompanying drawings, the specific configuration is not limited to the above-described embodiments and design and the like within the scope without departing from the subject matter of the invention are also included.

What is claimed is:

1. A control device comprising:
an input unit that pulls down or pulls up a signal input from an operating unit;
a control unit that executes a predetermined operation according to the signal input through the input unit; and
a power control unit that controls the control unit so as not to execute the predetermined operation and also controls the input unit so as not to pull down or pull up the signal according to a state of supplied electric power.

2. The control device according to claim 1, further comprising:
a charging detection unit that detects whether or not a secondary power supply unit, which is charged by an electromotive force generated by a primary power supply unit, is in an uncharged state in which the secondary power supply unit is not being charged by the primary power supply unit,
wherein when the charging detection unit detects that the secondary power supply unit is in the uncharged state, the power control unit controls the control unit so as not to execute the predetermined operation and also performs transition of the input unit to a power saving mode in which no control for pull-down or pull-up is performed.

3. The control device according to claim 2,
wherein when the charging detection unit detects that the secondary power supply unit is not in the uncharged state in the power saving mode, the power control unit controls the control unit to execute the predetermined operation and also performs transition of the input unit to a normal operation mode in which control for pull-down or pull-up is performed.

4. The control device according to claim 3,
wherein when it is determined that the secondary power supply unit is not in the uncharged state, the transition to the normal operation mode by the power control unit is performed on the basis of an output signal output from the input unit.

5. The control device according to claim 2, further comprising:
a voltage detection unit that detects a voltage of the secondary power supply unit,
wherein in a mode other than the power saving mode, the transition to the power saving mode by the power control unit is performed only when the charging detection unit detects that the secondary power supply unit is not in the uncharged state and the detected voltage of the secondary power supply unit is equal to or lower than a predetermined threshold value.

6. The control device according to claim 3, further comprising:
a voltage detection unit that detects a voltage of the secondary power supply unit,
wherein in a mode other than the power saving mode, the transition to the power saving mode by the power control unit is performed only when the charging detection unit detects that the secondary power supply unit is not in the uncharged state and the detected voltage of the secondary power supply unit is equal to or lower than a predetermined threshold value.

7. The control device according to claim 4, further comprising:
a voltage detection unit that detects a voltage of the secondary power supply unit,
wherein in a mode other than the power saving mode, the transition to the power saving mode by the power control unit is performed only when the charging detection unit detects that the secondary power supply unit is not in the uncharged state and the detected voltage of the secondary power supply unit is equal to or lower than a predetermined threshold value.

8. The control device according to claim 2,
wherein the power control unit performs transition to the power saving mode when the secondary power supply unit is in the uncharged state and this uncharged state continues for a predetermined time or more.

9. The control device according to claim 2,
wherein the power control unit performs transition to the power saving mode when a signal according to an operation set in advance is input from the operating unit, the secondary power supply unit is in the uncharged state, and this uncharged state continues for a predetermined time or more.

10. The control device according to claim 1,
wherein the control unit includes an oscillation circuit control section which generates a basic clock used for operation of the control unit by oscillation when the electric power is supplied, and
when the oscillation circuit control section stops oscillation of the basic clock which oscillates when the electric power is supplied, the power control unit controls the control unit so as not to execute the predetermined operation and also performs transition of the input unit to the power saving mode in which no control for pull-down or pull-up is performed.

11. The control device according to claim 10,
wherein in the power saving mode, the power control unit determines whether or not a potential difference of the electric power is equal to or higher than a potential difference, which is higher by a potential difference set in advance than a lower-limit potential difference at which a basic clock can oscillate in the oscillation circuit control section, and
when the potential difference of the electric power is equal to or higher than the potential difference which is higher by the potential difference set in advance than the lower-limit potential difference in the oscillation circuit control section, the power control unit controls the control unit to execute the predetermined operation and also performs transition of the input unit to a normal operation mode in which control for pull-down or pull-up is performed.

12. The control device according to claim 2,
wherein the input unit includes:
a pull-down or pull-up section which pulls down or pulls up the signal input from the operating unit; and
an output control section which outputs the signal, which is output to the control unit, after setting the signal level to a High or Low level in the power saving mode.

13. The control device according to claim 12,
wherein the output control section of the input unit includes an AND circuit or a NAND circuit,
the signal input from the operating unit through the pull-down or pull-up section is input to one input terminal of the AND circuit or the NAND circuit,
an output of the AND circuit or the NAND circuit is equivalent to an output of the input unit, and
the power control unit controls the other input terminal of the AND circuit or the NAND circuit to have a Low level in the power saving mode.

14. The control device according to claim 12,
wherein the output control section of the input unit includes a NOR circuit or an OR circuit,
the signal input from the operating unit through the pull-down or pull-up section is input to one input terminal of the NOR circuit or the OR circuit,
an output of the NOR circuit or the OR circuit is equivalent to an output of the input unit, and
the power control unit controls the other input terminal of the NOR circuit or the OR circuit to have a High level in the power saving mode.

15. The control device according to claim 12,
wherein the pull-down or pull-up section of the input unit performs pull-down or pull-up using a MOSFET, and
the power control unit turns off the MOSFET in the power saving mode.

16. The control device according to claim 12,
wherein the pull-down or pull-up section of the input unit performs pull-down or pull-up using a MOSFET and a resistor connected in series to the MOSFET, and
the power control unit turns off the MOSFET in the power saving mode.

17. The control device according to claim 1,
wherein the operating unit switches between an electrically conductive state, in which both terminals of the operating unit are connected to each other, and a cut-off state, in which both the terminals are disconnected from each other, when operated.

18. An electronic apparatus comprising the control device according to claim 1.

19. A timepiece device comprising the control device according to claim 1.

20. A control method in a control device including an input unit that pulls down or pulls up a signal input from an operating unit and a control unit that executes a predetermined operation according to the signal input through the input unit, the control method comprising:
controlling the control unit so as not to execute the predetermined operation and also controlling the input unit so as not to pull down or pull up the signal according to a state of supplied electric power by means of a power control unit.
